(19) United States
(12) Patent Application Publication
(10) Pub. No.: US 2008/0126371 A1
(43) Pub. Date: May 29, 2008

(54) COMPUTER-IMPLEMENTED METHOD FOR DERIVING PROSPECTIVELY PATENTABLE INVENTIONS UTILIZING INDICIA OF DIFFERENCES BETWEEN IDEAS ACCUMULATED IN A COMPUTER DATABASE

(75) Inventors: Jens Erik Sorensen, San Diego, CA (US); Jens Ole Sorensen, Rancho Santa Fe, CA (US)

Correspondence Address: KNOBBE MARTENS OLSON & BEAR LLP, 2040 MAIN STREET, FOURTEENTH FLOOR, IRVINE, CA, 92614, US

(73) Assignee: SORENSEN RESEARCH AND DEVELOPMENT TRUST, San Diego, CA (US)

(21) Appl. No.: 11/828,313

(22) Filed: Jul. 25, 2007

Related U.S. Application Data
(63) Continuation-in-part of application No. 10/309,384, filed on Nov. 25, 2002.
Application No. 10/309,384 is a division of application No. 10/072,071, filed on Feb. 8, 2002, now abandoned.
Application No. 10/072,071 is a continuation-in-part of application No. 09/980,654, filed on Oct. 25, 2001, now abandoned.
Application No. 09/980,654 is a continuation-in-part of application No. 10/371,255, filed on Feb. 21, 2003, now abandoned.
Application No. 10/371,255 is a continuation-in-part of application No. 10/072,071, filed on Feb. 8, 2002, now abandoned.
Application No. 10/072,071 is a continuation-in-part of application No. 09/980,654, filed on Oct. 25, 2001, now abandoned.
Application No. 09/980,654 is a continuation-in-part of application No. 10/371,255, filed on Feb. 21, 2003, now abandoned.
Application No. 10/371,255 is a continuation-in-part of application No. 10/019,155, filed on Oct. 25, 2001, now abandoned.
(60) Provisional application No. 60/224,944, filed on Aug. 11, 2000.
(60) Provisional application No. 60/227,687, filed on Aug. 24, 2000.
(60) Provisional application No. 60/224,944, filed on Aug. 11, 2000.
(60) Provisional application No. 60/227,687, filed on Aug. 24, 2000.
(60) Provisional application No. 60/227,687, filed on Aug. 24, 2000.

(51) Int. Cl. G06F 17/30

(52) U.S. Cl. 707/100; 707/E17.005

(57) ABSTRACT

A computer-implemented method for deriving prospectively patentable inventions including accumulating a plurality of the idea contributions for prospectively patentable inventions in a database, where at least one of the idea contributions comprises at least one parent idea contribution, at least one idea contribution from which the parent idea contribution was previously derived and at least one child idea contribution. The child idea contribution was derived from the parent idea contribution by editing of the parent idea contribution, and the child idea is a prospective improvement of the parent idea. The child idea contribution is displayed so as to include indicia of differences between the child idea contribution and the parent idea contribution, and so as to not include indicia of differences between the parent idea contribution and the idea contribution from which the parent idea contribution was previously derived.

### CROSS-REFERENCE TO RELATED APPLICATIONS

This application is a continuation-in-part of U.S. patent application Ser. No. 10/309,384 filed Nov. 25, 2002, which is a division of U.S. patent application Ser. No. 10/072,071 filed Feb. 8, 2002, which is a continuation-in-part of U.S. patent application Ser. No. 09/980,654 filed Oct. 25, 2001, which was the National Stage of International Application No. PCT/US01/25317 filed Aug. 10, 2001, which claims the benefit of U.S. Provisional Patent Application No. 60/224,944 filed Aug. 11, 2000 and U.S. Provisional Patent Application No. 60/227,687 filed Aug. 24, 2000, all of which are incorporated by reference. This application is also a continuation-in-part of U.S. patent application Ser. No. 10/371,255 filed Feb. 21, 2003, which is a continuation-in-part of U.S. patent application Ser. No. 10/072,071 filed Feb. 8, 2002, and U.S. patent application Ser. No. 10/019,155 filed Oct. 25, 2001, all of which are incorporated by reference. U.S. patent application Ser. No. 10/072,071 filed Feb. 8, 2002 is a continuation-in-part of U.S. patent application Ser. No. 09/980,654 filed Oct. 25, 2001, which was the National Stage of International Application No. PCT/US01/25317 filed Aug. 10, 2001, which claims the benefit of U.S. Provisional Patent Application No. 60/224,944 filed Aug. 11, 2000 and U.S. Provisional Patent Application No. 60/227,687 filed Aug. 24, 2000, all of which are incorporated by reference. U.S. patent application Ser. No. 10/019,155 filed Oct. 25, 2001 was the National Stage of International Application No. PCT/US01/26463 filed Aug. 24, 2001, which claims the benefit of U.S. Provisional Patent Application No. 60/227,687 filed Aug. 24, 2000, all of which are incorporated by reference.

### BACKGROUND OF THE INVENTION

1. Field of the Invention

The present invention pertains to management and publication of ideas for inventions that include indicia of differences and are accumulated in a computer database.

2. Description of Related Technology

A discovery of a problem, need or requirement calling for a solution is commonly an integral idea-component of an invention. The ideas may include needs, problems, solutions, requirements, discoveries and/or inventions and/or are accumulated prior to filing patent applications for inventions derived at least in part from the accumulated ideas.

### SUMMARY OF CERTAIN INVENTIVE ASPECTS

In one embodiment there is a computer-implemented method for deriving prospectively patentable inventions with a database, the method comprising (a) maintaining a computer database for accumulating idea contributions for prospectively patentable inventions; (b) establishing nondisclosure agreements by at least some prospective contributors of idea contributions for the database; (c) establishing contractual obligations by prospective contributors of idea contributions to the database to transfer property rights of the contributors to prospectively patentable inventions, derived at least in part from the contributed idea contributions; (d) editing the idea contributions in the database; (e) accumulating a plurality of the idea contributions in the database, wherein at least one of the idea contributions comprise at least one parent idea contribution, at least one idea contribution from which the parent idea contribution was previously derived, and at least one child idea contribution and wherein the child idea contribution was derived from the parent idea contribution by the editing of the parent idea contribution, and wherein the child idea is a prospective improvement of the parent idea; and (f) displaying the child idea contribution so as to include indicia of differences between the child idea contribution and the parent idea contribution and so as to not include indicia of differences between the parent idea contribution and the idea contribution from which the parent idea contribution was previously derived.

### BRIEF DESCRIPTION OF THE DRAWINGS

FIG. 1 is a diagram illustrating various aspects of the present invention.

FIG. 1A is a diagram showing in greater detail some of the “contractual obligations” by idea contributors shown only generally in the diagram of FIG. 1.

FIG. 1B is a diagram showing four alternative embodiments of the “enable viewing” function shown only generally in the diagram of FIG. 1.

FIG. 1C is a diagram showing in greater detail the “listings” shown only generally in the diagram of FIG. 1.

FIG. 2 is a diagram of an exemplary embodiment of the organization of an integrated idea in a computer database, wherein problem ideas are indicated by squares and solution ideas are indicated by circles.

FIGS. 3 through 60 are views of various screen displays provided from a website to a user upon accessing an idea database in accordance with the present invention, wherein FIGS. 19 through 42 are related to browsing the exemplary embodiment of the integrated idea that is organized as shown FIG. 2.

FIG. 61 is a diagram illustrating various aspects of the present invention.

FIG. 62 is a diagram of one preferred embodiment of the organization of an integrated idea in a computer database, wherein problem ideas are indicated by squares and solution ideas are indicated by circles.

FIGS. 63 through 66 are views of various screen displays provided from a website to a contributor upon accessing an idea database in accordance with the embodiment of the integrated idea that is organized as shown FIG. 62. FIG. 67 is a diagram of another preferred embodiment of the organization of an integrated idea in a computer database.

Views of screen displays overlapping two sheets of drawing are identified by a common FIG. number and A and B suffixes.

### DETAILED DESCRIPTION OF CERTAIN INVENTIVE EMBODIMENTS

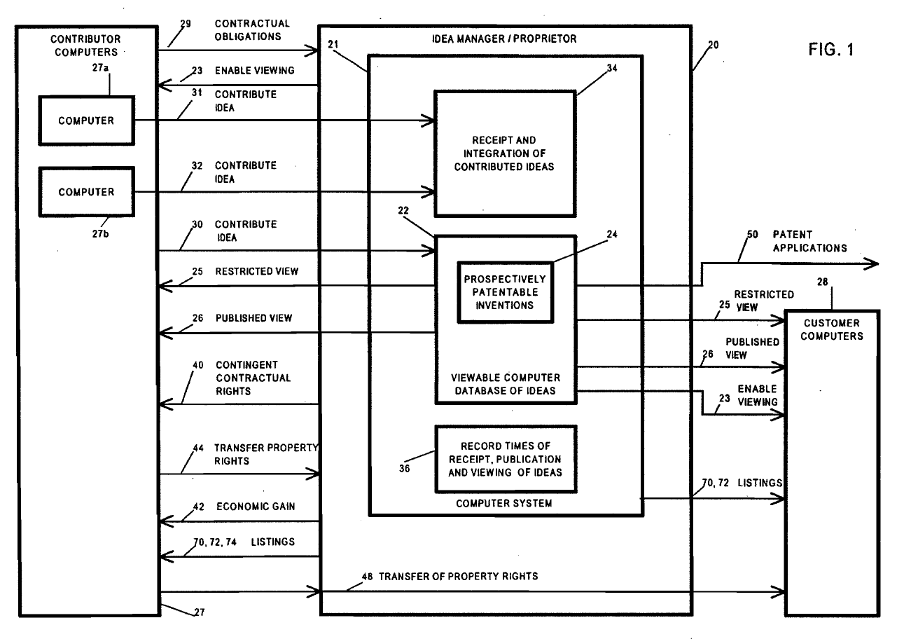

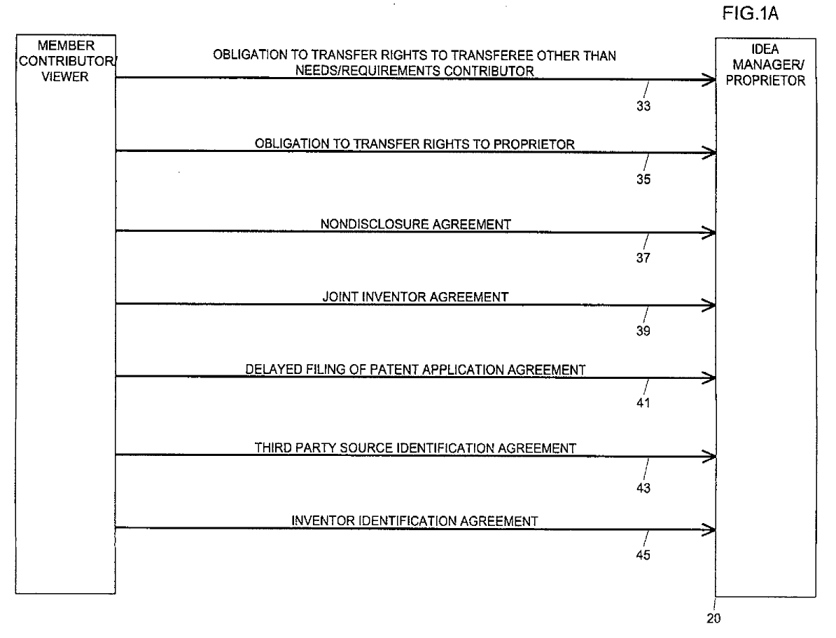

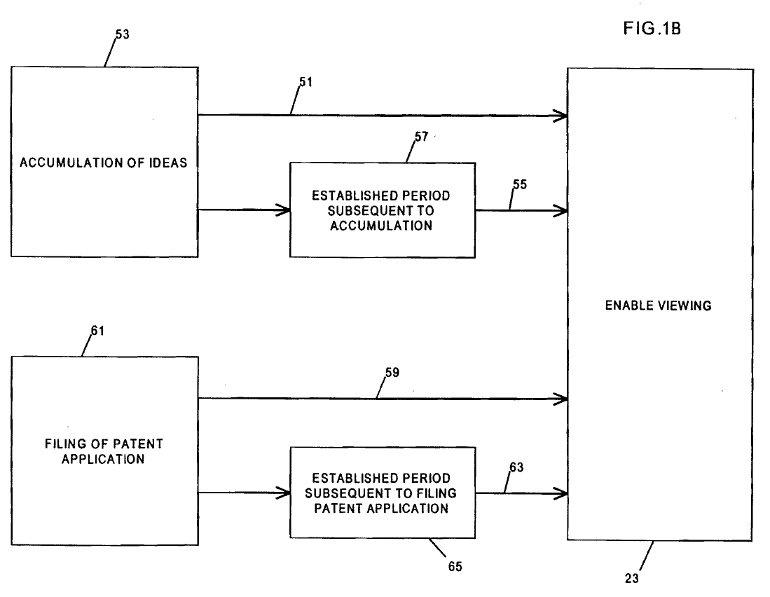

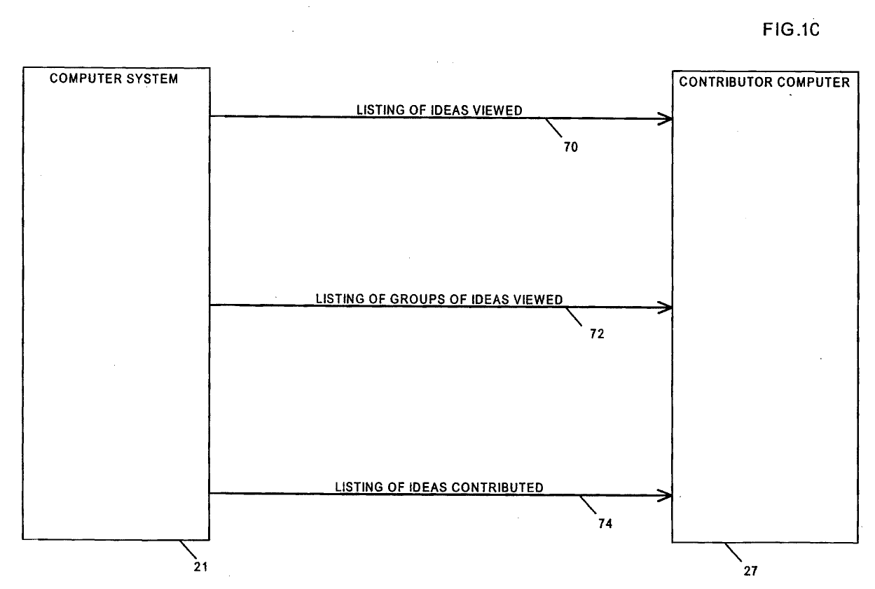

Referring to FIG. 1, in a preferred embodiment of the present invention, an idea manager 20 maintains a computer system 21 and a computer database 22 for accumulating ideas for prospectively patentable inventions. The accumulated ideas include needs and requirements of such inventions and/or are systematically accumulated prior to filing any patent applications for inventions respectively derived at least in part from the accumulated ideas. The idea manager 20 is the proprietor of the computer database 22. The computer system 21 is adapted by hardware, firmware and/or software for performing and/or enabling performance of the various methods described herein.

The computer system 21 may include one or more computers and one or more memories contained within or coupled to the computer(s). The idea manager 20 may be one party or different parties operating in concert with one another. Idea contributors use computers 27 to view 25, 26 the ideas accumulated in the database 22. One idea contributor can be the idea manager 20, including its staff and/or its computer system 21. Some contributor computers 27 may be shared by a plurality of contributors. Potential customers for property rights, including patent rights, to prospectively patentable inventions 24 derived at least in part from the ideas accumulated in the database 22 use computers 28 to view 25, 26 the accumulated ideas in the database 22 when viewing is enabled 23 by the computer system 21. In some embodiments, the contributor computers 27 may be the same as the customer computers 28 and/or the computers of the computer system 21. Some viewings 25 of the ideas from the database 22 are so restricted by non-disclosure agreements by the viewers as not to constitute a publication of the ideas; and some viewings 26 of the ideas from the database 22 are enabled without restriction and thereby constitute a publication of the ideas.

The computer system 21 is programmed by the idea manager 20 to facilitate use of the contributor computers 27 to make on-line contributions of ideas 30, 31, 32 to the computer database of ideas 22. Computer programs that enable the contributor computers 27 to be used to make on-line contributions of ideas to the database 22 can be downloaded by the contributor computers 27 from the computer system 21. An on-line contribution is a contribution that is made over a communication network, such as the Internet.

In some preferred embodiments, the computer system 21 is programmed to require persons to enter into a membership as a prerequisite for viewing a portion of the database 22 containing at least some of the accumulated ideas, and to facilitate entry into such membership by on-line communications between the computer system 21 and the contributor computers 27. Entry into such a membership can also be effected by other means, such as by mail. Upon entering into a viewer membership, a person agrees to give up some legal rights. In alternative embodiments, no such membership is required for on-line viewing of any portion of the database 22 by the general public.

In some preferred embodiments, the computer system 21 is programmed to require contributors of ideas for prospective entry into the database 22 to enter into a membership as a prerequisite for contributing ideas for entry into the database 22, and to facilitate entry into such membership by on-line communications between the computer system 21 and the contributor computers 27. Entry into such a membership can also be effected by other means, such as by mail. Upon entering into a contributor membership, a person agrees to give up some legal rights and/or to transfer some property rights with respect to ideas contributed by such person. In some of the embodiments with such a membership requirement, the membership is limited to any entity that agrees to transfer or otherwise encumber property rights, including patent rights, to any inventions derived from any idea contributed by the entity. In alternative embodiments, no such membership is required for contributing ideas for entry into the computer database 22.

In some preferred embodiments, the computer system 21 is programmed to systematically establish contractual obligations 29 by contributors of the ideas to the database 22 and to facilitate establishment of such obligations 29 by on-line communications between the computer system 21 and the contributor computers 27. With regard to some of the contractual obligations 29, in some embodiments the persons that are obligated generally are not employees of the proprietor 20 or employees of a party in concert with the proprietor 20.

Referring to FIG. 1A, in the preferred embodiments, these systematically established contractual obligations 29 include one or more of the following: obligations 33 by contributors of ideas to the computer database 22 to transfer property rights, including patent rights, to inventions respectively derived at least in part from the contributed ideas to transferees other than contributors of ideas of needs and/or requirements of the respectively derived inventions;

obligations 35 by contributors of ideas to the computer database 22 to transfer property rights, including patent rights, to inventions respectively derived at least in part from the contributed ideas to the proprietor 20 of the computer database 22 or to a party in concert with the proprietor 20;

nondisclosure agreements 37 pertaining to given ideas accumulated in the database 22 and consummated by persons whom have entered into a membership as a prerequisite for contributing ideas to the computer database 22 and/or for viewing the accumulated ideas;

joint inventor agreements 39 consummated by persons whom have entered into a membership as a prerequisite for contributing ideas to the computer database 22 and/or for viewing the accumulated ideas and agreeing to file as a joint inventor any patent application for any invention derived from a combination of any ideas contributed to the database 22 by such person and given accumulated ideas contributed to the database 22 by other persons;

delayed filing of patent application agreements 41 consummated by persons whom have entered into a membership as a prerequisite for contributing ideas to the computer database 22 and/or for viewing the accumulated ideas and agreeing not to file, without permission of the proprietor 20 of the computer database 22, a patent application for any invention related to a given idea accumulated in the database 22 until after an established period of time subsequent to accumulation of the given idea;

third party source identification agreements 43 consummated by persons whom have entered into a membership as a prerequisite for contributing ideas to the computer database 22 and/or for viewing the accumulated ideas and agreeing to disclose the identity of any third-party sources of ideas contributed by such person that are related to given ideas accumulated in the database 22; and

inventor identification agreements 45 consummated by persons whom have entered into a membership as a prerequisite for contributing ideas to the computer database 22 and/or for viewing the accumulated ideas and agreeing to disclose the identity of each inventor of any invention derived from ideas contributed by such person that are related to given ideas accumulated in the database 22.

In some embodiments, the idea manager 20 facilitates transfer of property rights 44, 48 by the contributors of ideas to the computer database 22. In some of these embodiments, the transfer of property rights 44, 48 is to transferees other than contributors of ideas from which the invention was at least in part derived. In some of the embodiments, the transfer of property rights 44 is to a proprietor of the database 22, such as the idea manager 20, or to a party in concert with such proprietor 20. In some of these embodiments, the transferees are not identified upon establishing such obligations; and in some of these embodiments, the transferees are identified upon establishing such obligations.

In some embodiments, the transfer of property rights 44, 48 and/or the contractual obligations 29 to transfer property rights are in exchange for contingent economic gain, such as for example: contingent contractual rights 40 or shares of a portfolio of such contractual rights, or stock in the database proprietor 20 or a party in concert with the database proprietor 20. In some of these embodiments, the transfer of property rights 48 and/or the contractual obligations 29 to transfer property rights are in exchange for actual economic gain 42, such as for example: cash or bonds.

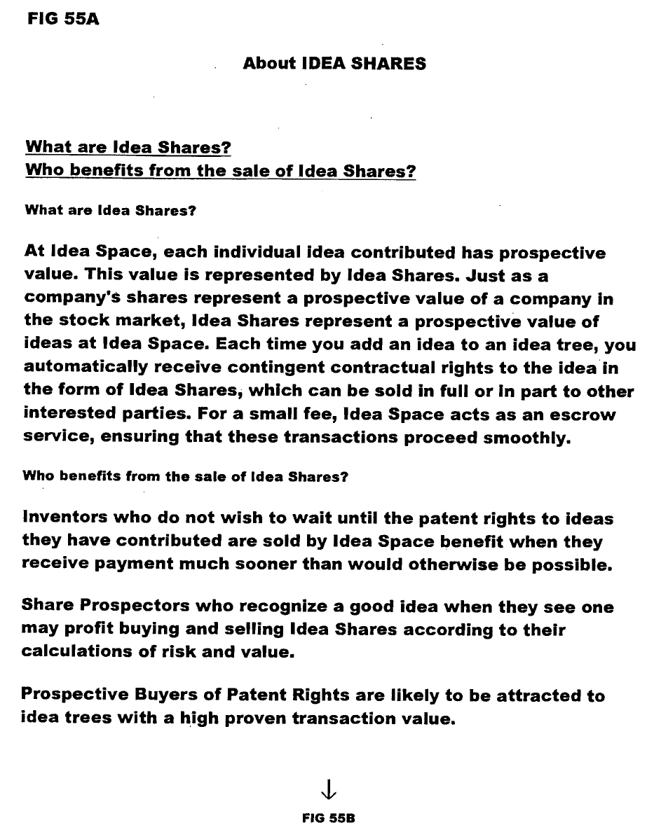

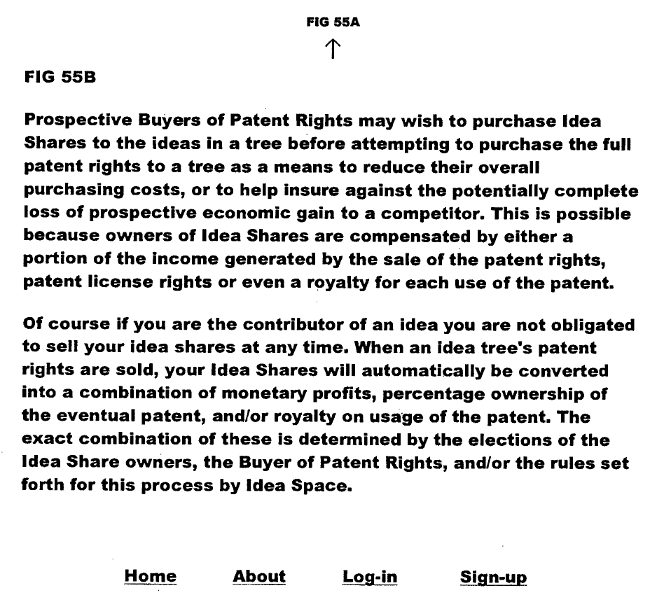

In some embodiments, the computer system 21 is programmed to systematically provide the contributors of ideas with contingent contractual rights 40 to at least some inventions derived at least in part from the ideas accumulated in the database 22, and to facilitate provision of such contingent rights in a marketable format, such as an electronically tradable certificate, by on-line communications between the computer system 21 and the contributor computers 27, or as described below with reference to FIGS. 55-60. The idea manager 20 systematically provides contingent contractual rights 40 to at least some of the contributors of ideas to the database 22 as an incentive for all or selected contributors to contribute ideas to the database 22; and/or compensates by economic gain 42 at least some contributor-owners of the contingent contractual rights in exchange for either acquiring 44 or facilitating transfer 48 of at least some of the property rights. The contingent contractual rights 40 include rights to a portion of anticipated income derived from property rights under the patent rights to prospectively patentable inventions 24 derived at least in part from the ideas contributed by the contributors whom receive such contingent contractual rights 40.

The computer system 21 is programmed to enable receipt of contributions of ideas for prospective entry into the database 22, and to facilitate receipt of such contributions on-line from the contributor computers 27. In some preferred embodiments, the computer system 21 is programmed to systematically enter into the database 22 all the ideas contributed for entry into the database 22 without requiring any contributor of such ideas to have subject matter expertise as a prerequisite for entry of such contributions. In other preferred embodiments, the computer system 21 is programmed to require contributors of ideas to the database 22 to have subject matter expertise as a prerequisite for contributing ideas for prospective entry into the database 22, and facilitate entry of evidence of such expertise by on-line communications between the computer system 21 and the contributor computers 27. Such evidence can also be effected by other means, such as by mail. In still other preferred embodiments, the computer system 21 is programmed to selectively enter only some of the contributed ideas into the database 22. In some embodiments, selective entry is accomplished by systematic computer screening for relevant subject matter. In some embodiments, selective entry is accomplished by systematic computer screening for keywords and by a computer operator making a selective entry decision based upon the context in which the keywords are used.

In alternative preferred embodiments, the computer system 21 is programmed to enable persons, whom have entered into a membership as a prerequisite for contributing ideas to the computer database 22 and/or for viewing the ideas accumulated in the database 22, and have consummated nondisclosure agreements 37, joint inventor agreements 39, delayed filing of patent application agreements 41, third party source identification agreements 43 and/or inventor identification agreements 45, as described above with reference to FIG. 1A, to contribute ideas to the computer database 22.

In some preferred embodiments, the computer system 21 is programmed to systematically establish contractual obligations by the idea contributors to permit immediate public disclosure of the ideas contributed by the idea contributors, and to facilitate establishment of such obligations by on-line communications between the computer system 21 and the contributor computers 27. Preferably such permission is for immediate public disclosure of all of the ideas contributed by the contributor undertaking such contractual obligation. In some of these embodiments, the ideas received from such contributors and accumulated in the computer database 22 are immediately disclosed to the public upon receipt by entry into a publicly viewable portion of the database 22 and thereby systematically published prior to filing any patent applications for inventions respectively derived at least in part from such accumulated ideas. In other such embodiments, the disclosure is not effected or not effected immediately notwithstanding having permission to do so.

In some preferred embodiments, the computer system 21 is programmed to record (a) the time of receipt of each idea contributed for entry into the database 22; (b) the time of publication in the database 22 of each accumulated idea; (c) the time of first viewing of each idea contributed to the database; and/or (d) the time of first public viewing from the database 22 of each accumulated idea, as indicated at 36 in FIG. 1.

In alternative preferred embodiments, the computer system 21 is programmed to enable 23 persons, whom have entered into a membership as a prerequisite for contributing ideas to the computer database 22 and/or for viewing the ideas accumulated in the database 22, and/or have consummated nondisclosure agreements 37, joint inventor agreements 39, delayed filing of patent application agreements 41, third party source identification agreements 43 and/or inventor identification agreements 45, as described above with reference to FIG. 1A, to view 25, 26 accumulated ideas from the computer database 22, including ideas not respectively contributed by such persons.

In some embodiments, the computer system 21 is programmed to enable 23 persons, whom have not entered into a membership as a prerequisite for viewing the ideas accumulated in the database 22, to view 26 accumulated ideas from the computer database 22, including ideas not respectively contributed by such persons.

Four different embodiments of the timing of the enable viewing function 23 are described with reference to FIG. 1B. These four embodiments are applicable for viewing by both persons whom have entered into a membership as a prerequisite for contributing ideas to the computer database 22 and/or for viewing the ideas accumulated in the database 22 and persons whom have not entered into such a membership.

In one such embodiment, as shown by line 51, viewing of a given accumulated idea in the database 22 is systematically enabled 23 immediately subsequent to accumulation 53 of the given idea in the database 22.

In another such embodiment, as shown by line 55, viewing of a given accumulated idea in the database 22 is systematically enabled 23 only after an established period of time 57 subsequent to accumulation 53 of the given idea in the database 22.

In still another such embodiment, as shown by line 59, viewing of a given accumulated idea in the database 22 is systematically enabled 23 immediately subsequent to filing a patent application 61 for an invention derived at least in part from the given accumulated idea.

In a further embodiment, as shown by line 63, viewing of a given accumulated idea in the database 22 is systematically enabled 23 only after an established period of time 65 subsequent to the filing a patent application 61 for an invention derived at least in part from the given accumulated idea.

The respective established periods of time subsequent to accumulation of the given idea 57, and subsequent to filing of a patent application 65 may be different per se and may be different with respect to enablement of viewing by persons whom have entered into such a membership and enablement of viewing by persons whom have not entered into such a membership.

Referring to FIG. 1C, the computer system 21 is programmed to systematically communicate online individually to computers 27 of persons, whom have entered into a membership as a prerequisite for contributing ideas to the computer database 22 and/or for viewing the ideas accumulated in the database 22, a listing 70 of ideas viewed from the database by said persons, a listing 72 of groups that include ideas viewed from the database by such persons; and/or a listing 74 of ideas contributed to the database by such persons.

The computer system 21 is programmed to enable ideas contributed by one or different contributors to the database 22 to be integrated within the database 22 to thereby facilitate derivation of inventions 24 from the integrated ideas, as indicated at 34 in FIG. 1. For example, a first idea 31 contributed by a first member using the computer 27a is integrated with a second idea 32 contributed by a second member using the computer 27b to provide an integrated idea of a prospectively patentable invention 24. In another example, ideas contributed from the same computer by one or different contributors are integrated within the database 22.

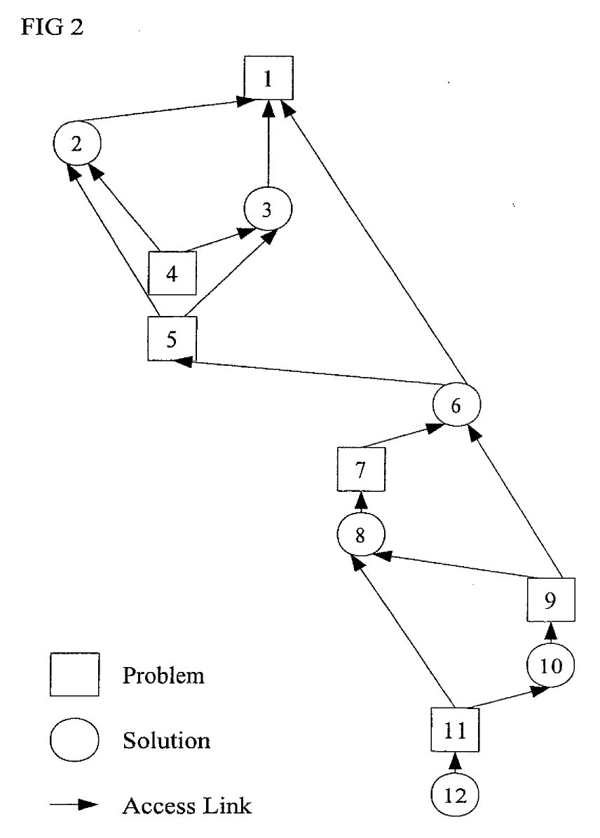

In the preferred embodiment, the related ideas that are processed to provide an integrated idea include problems and solutions. Preferably, an integrated idea is organized in the database as shown in FIG. 2 by providing access links between a problem idea (square) and one or more solution ideas (circle), and access links between a solution idea and one or more problem ideas, but generally not between a plurality of problem ideas or between a plurality of solution ideas. In this exemplary embodiment, three solution ideas 2, 3, 6 have been contributed in response to contribution of an initial problem idea 1; two problem ideas 4, 5 have been contributed in response to contribution of both of the solution ideas 2, 3, a solution idea 6 has been contributed in response to both of the problem ideas 1, 5; two problem ideas 7, 9 have been contributed in response to contribution of the solution idea 6; a solution idea 8 has been contributed in response to the problem idea 7; a problem idea 9 has been contributed in response to both of the solution ideas 6, 8; a solution idea 10 has been contributed in response to the problem idea 9; a problem idea 11 has been contributed in response to both of the solution ideas 8, 10; and a solution idea 12 has been contributed in response to the problem idea 11.

The idea contributions shown in FIG. 2 are described below in chronological order.

### Problem Idea 1: Breaking Spectacles

Spectacle frames often break so that a lens will not adhere to the frame and the frame may twist out of shape and not tack on to the head. The spectacle user often is dependent on only one set of spectacles and it may take a week before they can have new frame or spectacles or have the old frame fixed. Is there a simple way for an ordinary person to temporarily fix her glasses?

### Solution Idea 2: Use Glue

Glue the frame together with super glue.

### Solution Idea 3. Use Glue

Glue the frame to the glass and buy new spectacles.

### Problem Idea 4: Glue Doesn't Work

I have tried gluing with all kinds of glue but nothing has worked.

### Problem Idea 5: Glue Doesn't Work

Spectacle frames are made of glass and all kinds of plastics and all kinds of metals, it is not likely that any glue can be made which will glue all of these materials. See Reference “Fix It Yourself”

### Solution Idea 6: Use Shrink Wrap Tubes

I have access to the “Co-Brain” software, which suggests the alternative “fasten with shrink-wrap” to “fasten with glue”. Maybe you could have a small tube of shrink-wrap in the shape of a soda-straw, fit the lens and spectacles together so that the thin and soft shrink-wrap fits over the broken section of the frame and put the spectacles in the micro-oven for shrinking.

### Problem Idea 7: Tubes Don't Fit

The soda straw solution will only work for some lucky cases. Most often the spectacle frame breaks near the arch or the ear attachment and the soda straw solution will not work because the tube will only fit on one side of the broken frame.

### Solution Idea 8: Shrink Wrap Entire Frame

(1) Make a larger tube of shrink wrap with a diameter about the size of the frame around the lens, (2) Cut a thin sliver from the end of the tube with scissors in the form of a circular band, (3) Combine the spectacle parts and wrap the band around the broken frame around the lens, and (4) Use a hair dryer or other means to heat the combination.

### Problem Idea 9: Lacks Appeal

The color of the shrink-wrap could in some cases look very ugly.

### Solution Idea 10: Clear Choice

The shrink-wrap should be transparent.

### Problem Idea 11: Unsuitable Plastic

Some shrink-wraps would not be suitable because they are not elastic enough for the fit of the circular band around the broken frame around the lens.

### Solution Idea 12: Suitable Plastic

A suitable plastic can be bought from “Doww Chemicals” and is called Chemical X.

Reference: “Doww Plastic Facts”

The idea manager provides a website from which the computer database of ideas can be accessed for viewing and/or for entry of ideas into the computer database. Access to the database usually is over the Internet. A display of the web site provides a menu from which a user may select listings of (a) titles of the most recently contributed ideas; (b) titles of ideas that have received the most hits by users accessing the database; (c) integrated ideas combining the greatest number of prior ideas (such as the individual files respectively providing reference to the greatest number of files that are related either directly or indirectly to the identification code of another idea in the database); (d) the most recent integrated ideas (e) the identification codes of the contributors whom have supplied the most ideas to the database; and (f) the identification codes of the contributors whom have supplied the most ideas to the database for which rights have been provided/transferred. Such listings include links for accessing the ideas listed therein. Users can register for being notified by email of new entries of ideas having selected key words in the idea title and/or text; and such users are then so notified. The email notification includes a link to the new entry in the database.

A contributor enters an idea by text and/or attachment entry and/or by using software downloaded from the idea manager's website, or otherwise provided by the idea manager (such as in a CD), to enter drawings.

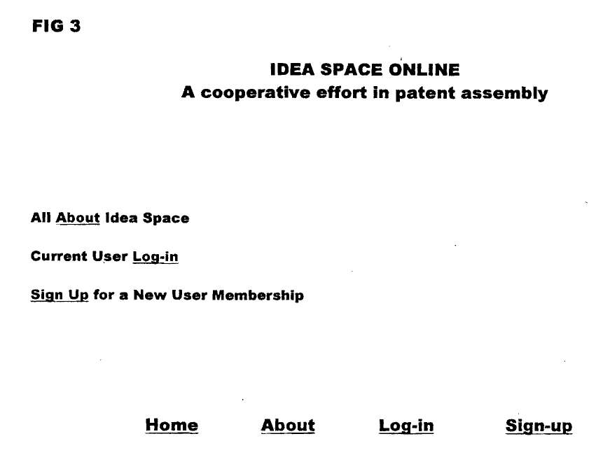

In an exemplary embodiment, the website is named “Idea Space”. The display screens that are provided to a user of the idea database are shown in FIGS. 3 through 54. The underlined portions of the various display screens provide links to either other display screens or to other portions of the display screen then being displayed.

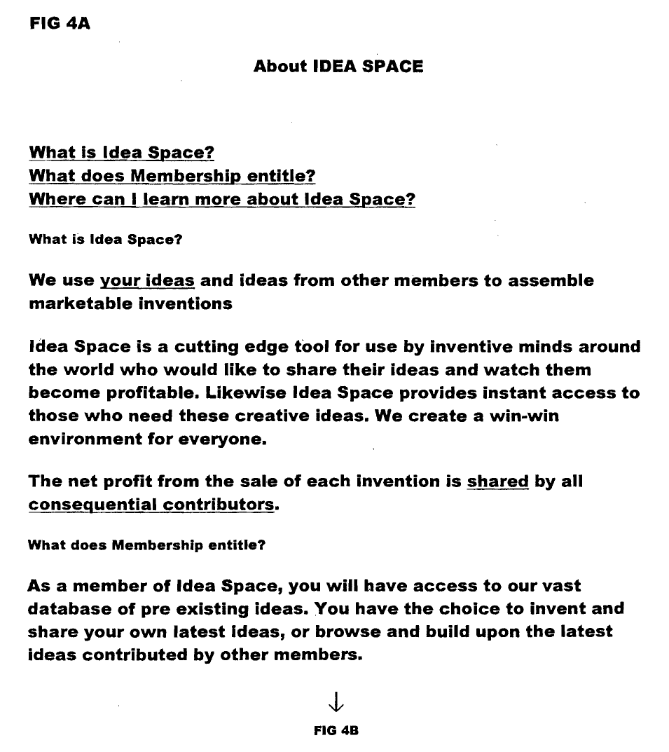

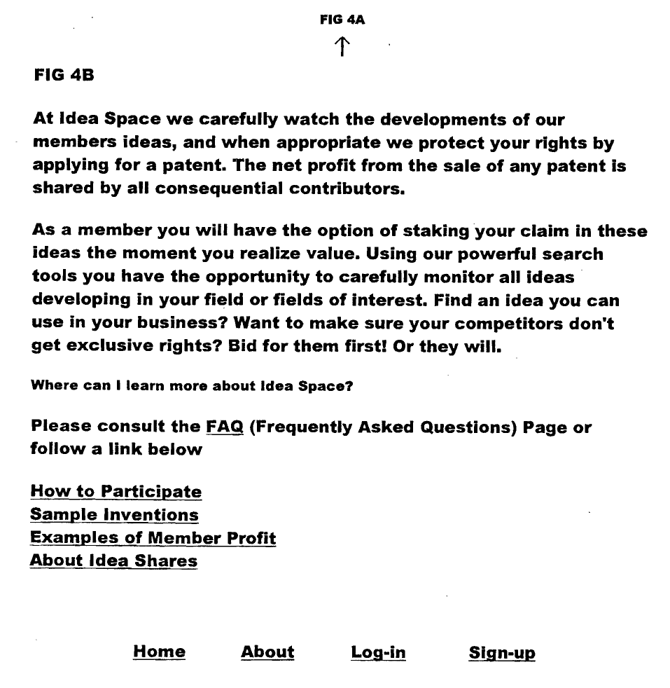

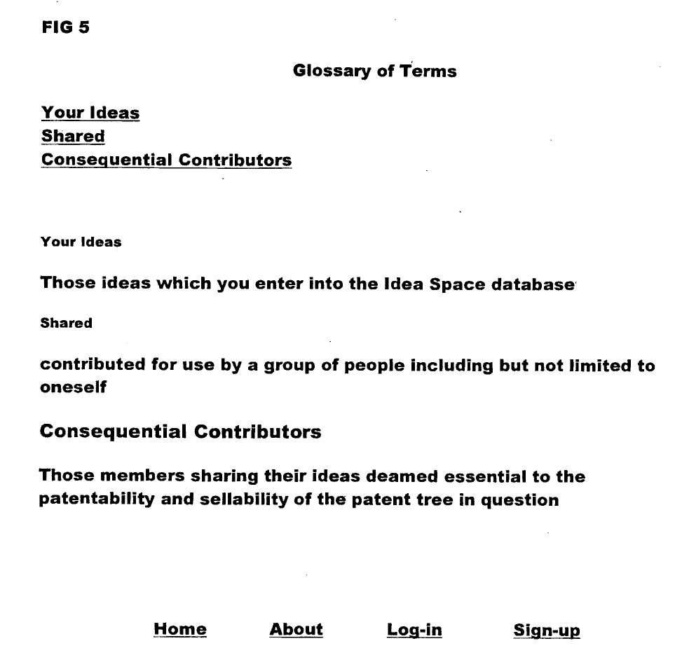

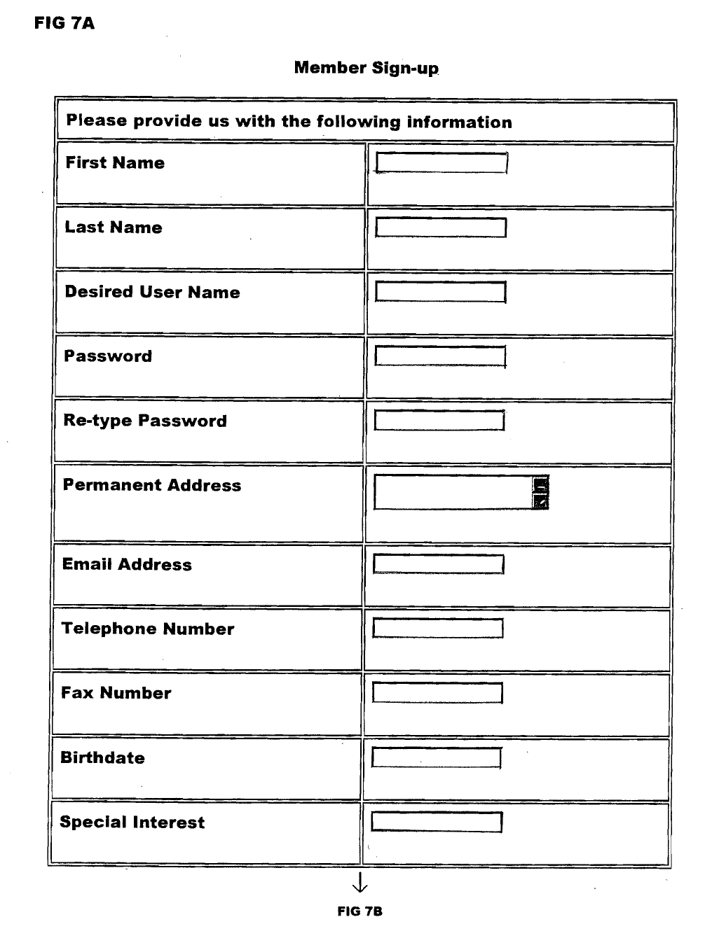

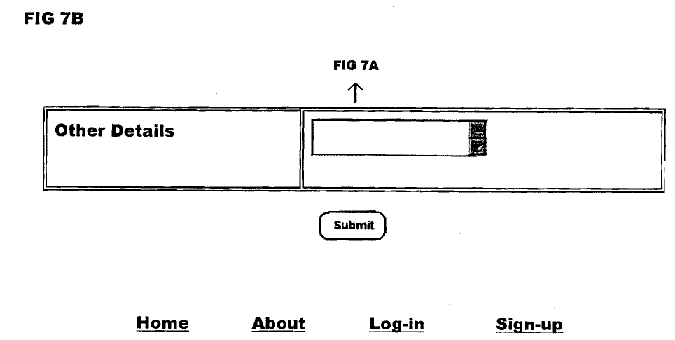

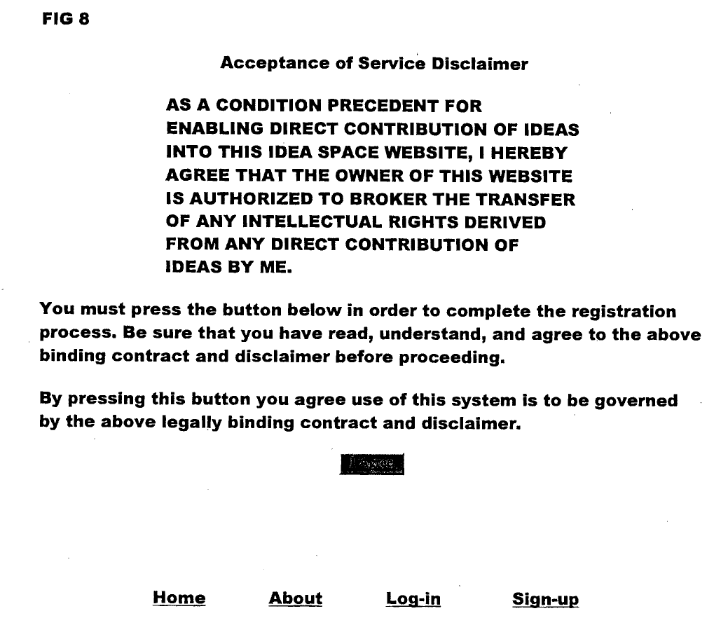

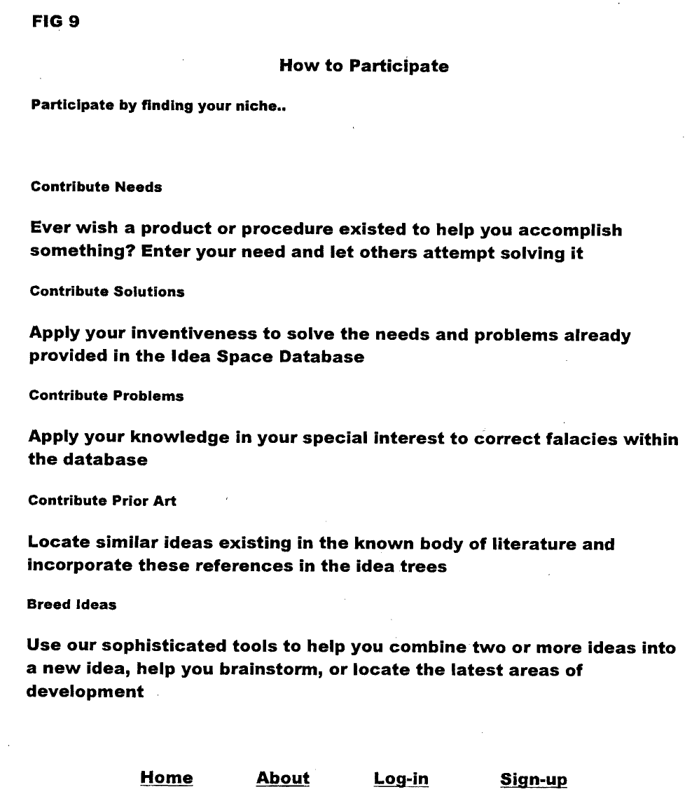

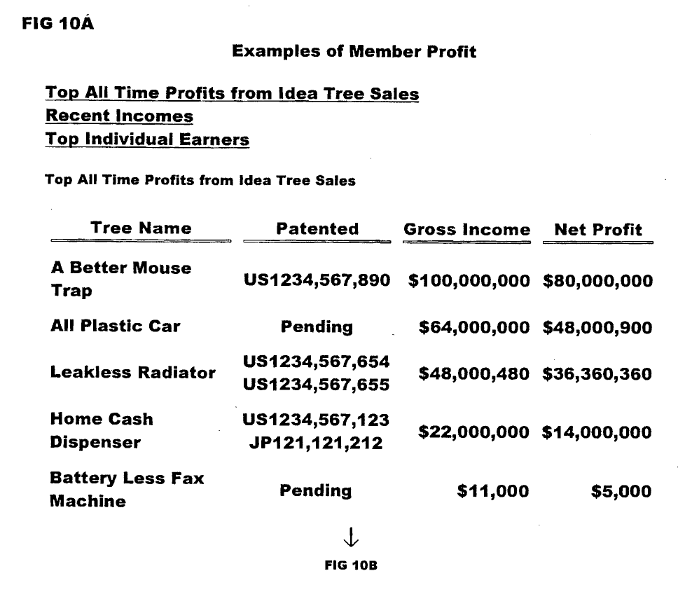

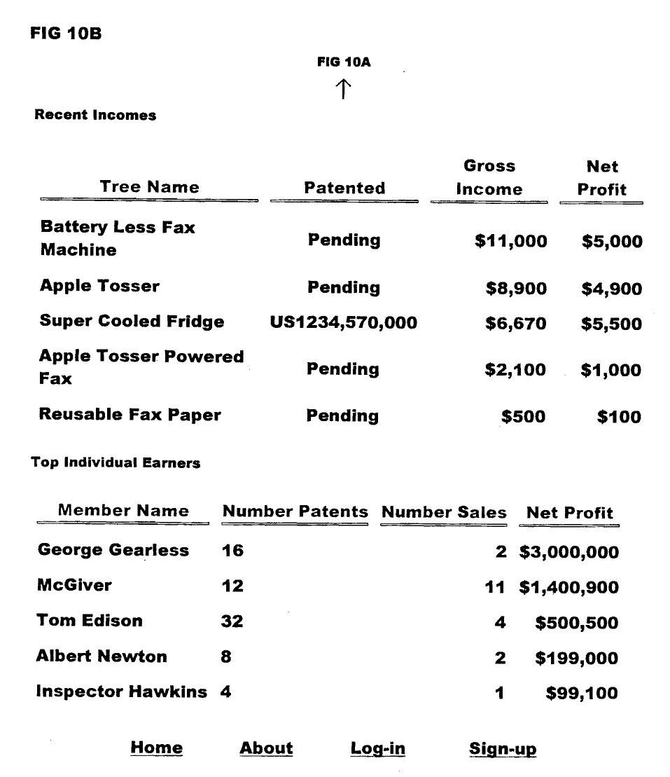

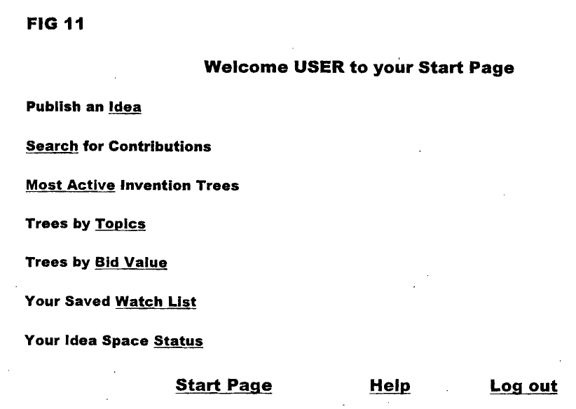

The screen display of the home page of the website is shown in FIG. 3. The home page provides links to the screen displays shown in FIGS. 4, 6 and 7. The underlined text in the “What is Idea Space” section of the “About Idea Space” screen display of FIG. 3 provides links to definitions of the respective underlined text in a “Glossary of Terms” screen display shown in FIG. 5. The “Submit” button at the bottom of the “Member Sign-up display screen of FIG. 7 provides a link to the “Acceptance . . . ” display screen shown in FIG. 8. Links to the “How to Participate” display screen of FIG. 9 and the “Examples of Member Profit” display screen of FIG. 10 are provided near the bottom of the “About Idea Space” display screen of FIG. 4.

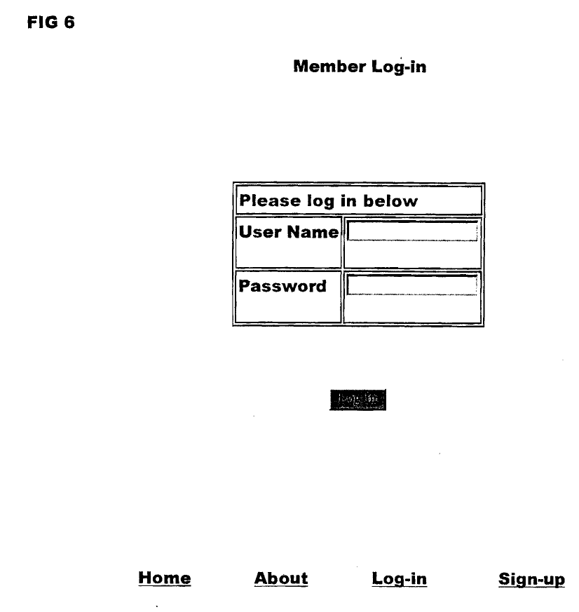

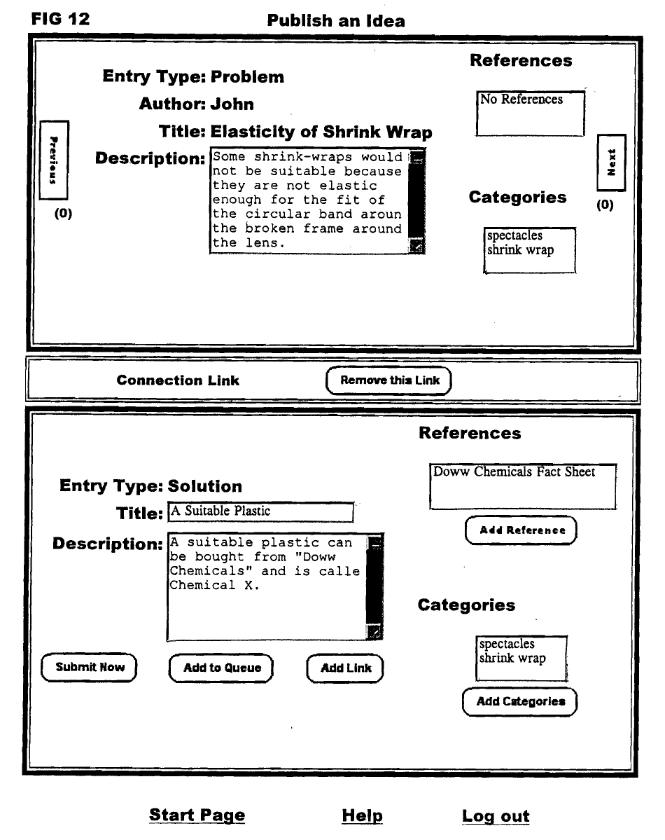

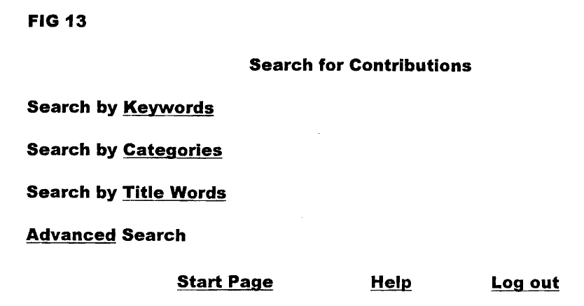

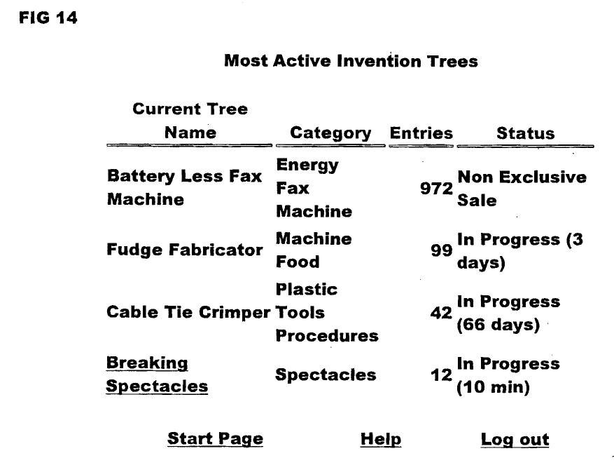

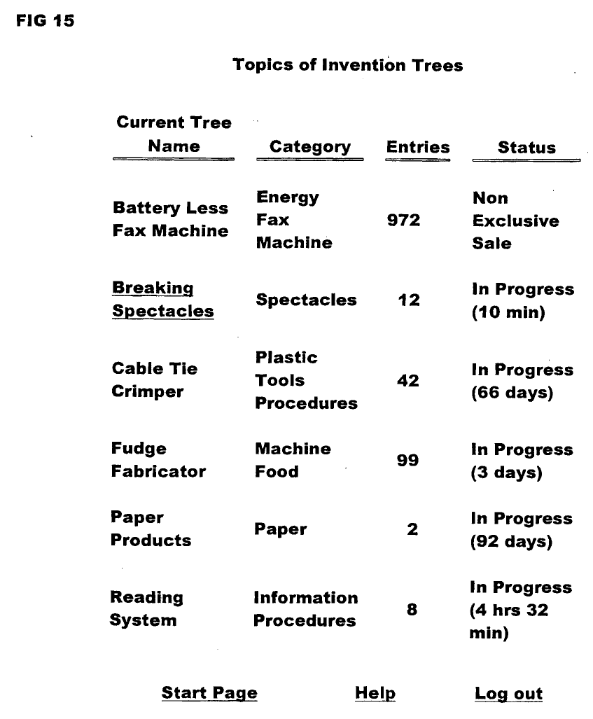

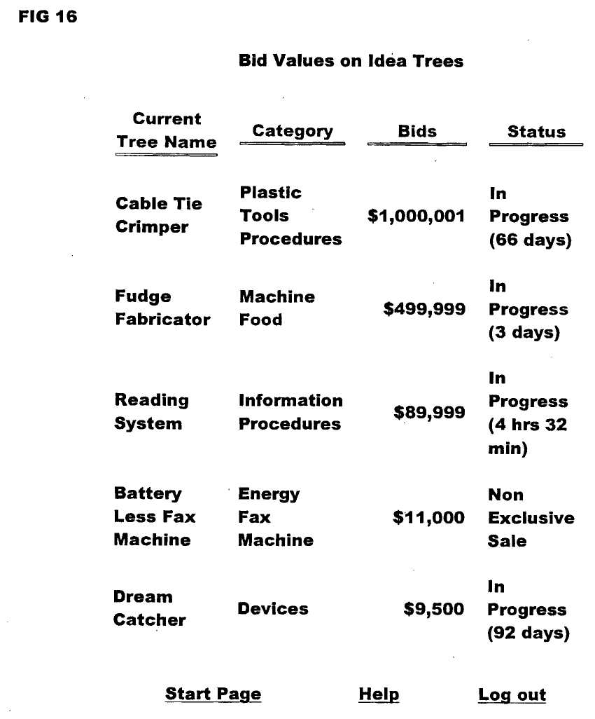

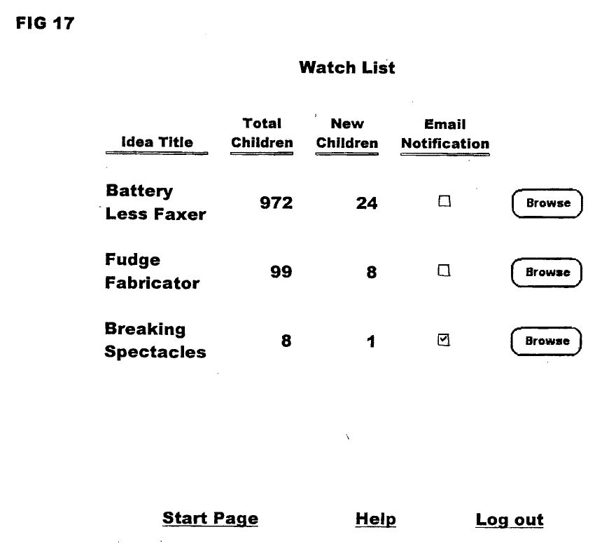

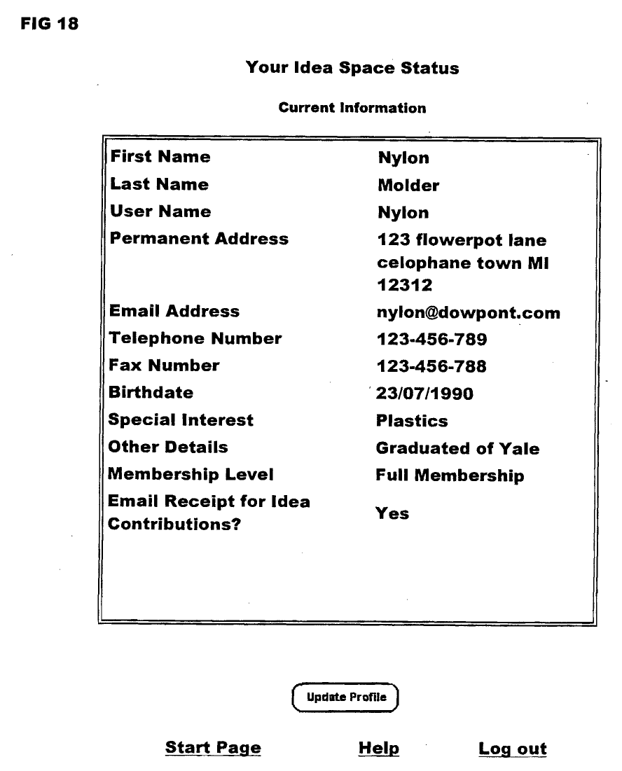

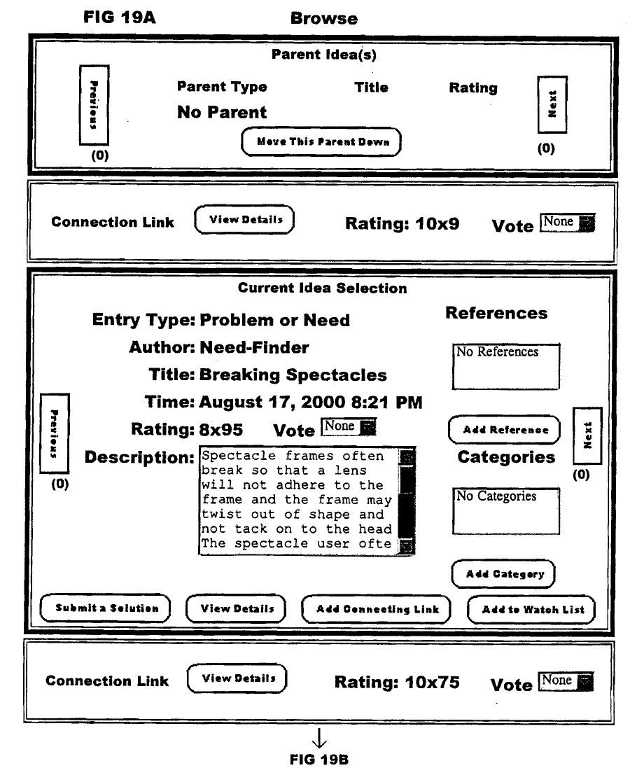

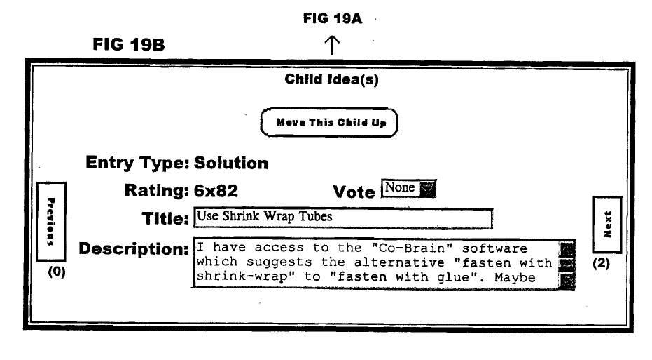

A link to the Start Page screen display of FIG. 11 is provided by the “log in” button on the Member Log-in screen display of FIG. 6. Referring to the Start Page screen display, clicking the “Publish an Idea” link provides the screen display of FIG. 12; clicking the “Search for Contributions” link provides the screen display of FIG. 13; clicking the “Most Active Invention Trees” link provides the screen display of FIG. 14; clicking the “Trees by Topics” link provides the screen display of FIG. 15; clicking the “Trees by Bid Value” link provides the screen display of FIG. 16; clicking the “Your Saved Watch List” link provides the screen display of FIG. 17; and clicking the “Your Idea Space Status” link provides the screen display of FIG. 18.

Upon displaying the “Topics of Invention Trees” screen display of FIG. 15, a user can select and browse prior contributions that have been published in the database. The “Breaking Spectacles” link provides access to the exemplary integrated idea described above with reference to FIG. 2, beginning with the screen display of FIG. 19. The format of the screen display for a selected idea (as shown in FIGS. 19-42) includes a “Current Idea Selection” section, a Parent section, a “Child Idea(s)” section, a first “Connection Link” section between the Parent section and the Current Idea Selection section, and a second “Connection Link” section between the Child Idea(s) section and the Current Selection section.

The Current Idea Selection section contains a Description of the selected idea and a Vote window and lists the Entry Type of the selected idea, such as “Problem or Need” or “Solution”; the Author (contributor) of the selected idea, the Title of the selected idea, the Time of publication of the selected idea, a Rating of the appropriateness of the selected idea, any References related to the selected idea, and any Categories related to the selected idea. The Current Idea Selection section also includes Previous and Next buttons for accessing other contributed ideas that are linked to the same parent idea as the selected idea. The quantity of any such other linked contributed ideas are indicated beneath the Previous and Next buttons.

The Parent section contains a Vote window and lists the Type of the linked parent idea, such as “Problem or Need” or “Solution”; the Title of the linked parent idea, and, a Rating of the appropriateness of the linked parent idea. The Parent section also includes Previous and Next buttons for accessing other contributed parent ideas that are linked to the selected idea, and indicates the quantity of any such other linked contributed parent ideas.

The Child Idea(s) section contains a Description of the linked child idea and a Vote window and lists the Entry Type of the linked child idea, such as “Problem or Need” or “Solution”; the Title of the selected idea, and a Rating of the appropriateness of the linked child idea. The Child Idea(s) section also includes Previous and Next buttons for accessing other contributed child ideas that are linked to the selected idea, and indicates the quantity of any such other linked contributed child ideas.

The ratings are provided in response to averaging (or processing by some other formula) the votes by users of the database. Voting is accomplished by selecting a number within a range of 0 to 10 from a drop-down menu displayed by clicking the down-arrow in the Vote window. The listed rating shows the average (or other) rating and the number of voters. Ratings are also listed in the two “Connection Link” sections for the appropriateness of the respective links between the selected idea and either the idea in the Parent section or the idea in the Child Idea(s) section. The ratings provide a user of the database with an immediate indication of the appropriateness of the rated idea or connection link, as voted by other users.

In the screen display of FIG. 19, the selected idea described in the Current Idea Selection section is Problem Idea 1, and the child idea described in the Child Idea(s) section is Solution Idea 6, as described above with reference to FIG. 2. In the Child Idea(s) section, the “(2)” indication beneath the Next button indicates that there are two other child ideas linked to selected Problem Idea 1.

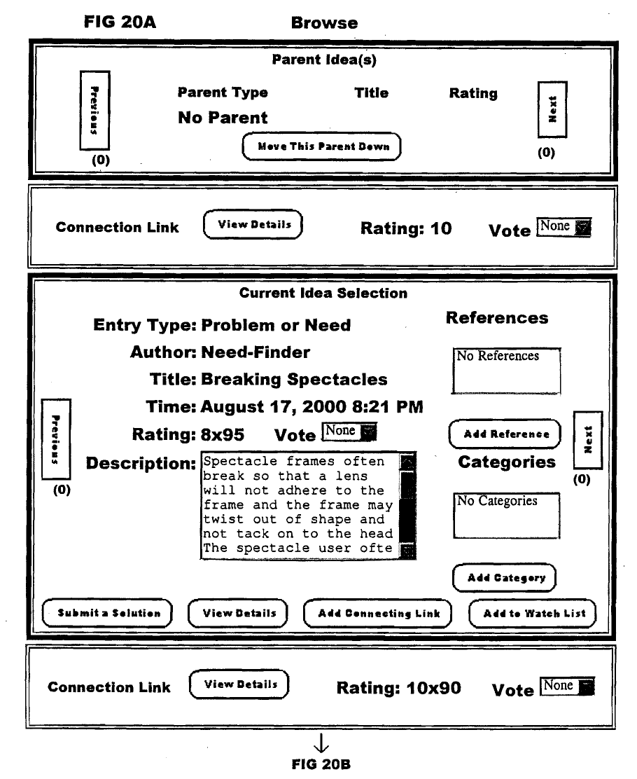

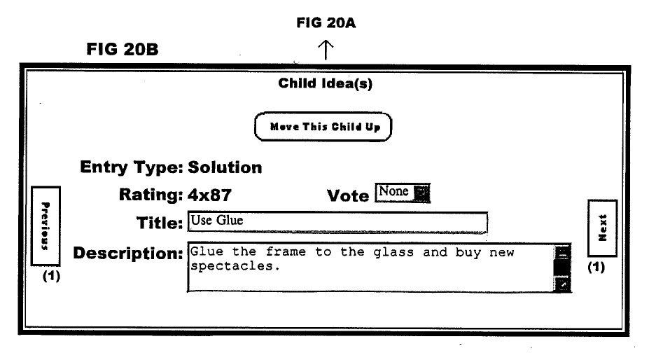

Clicking the Next button in the Child Idea(s) section of the screen display of FIG. 19 provides access to the screen display of FIG. 20, wherein the selected idea described in the Current Idea Selection section is Problem Idea 1, and the child idea described in the Child Idea(s) section is Solution Idea 3, as described above with reference to FIG. 2.

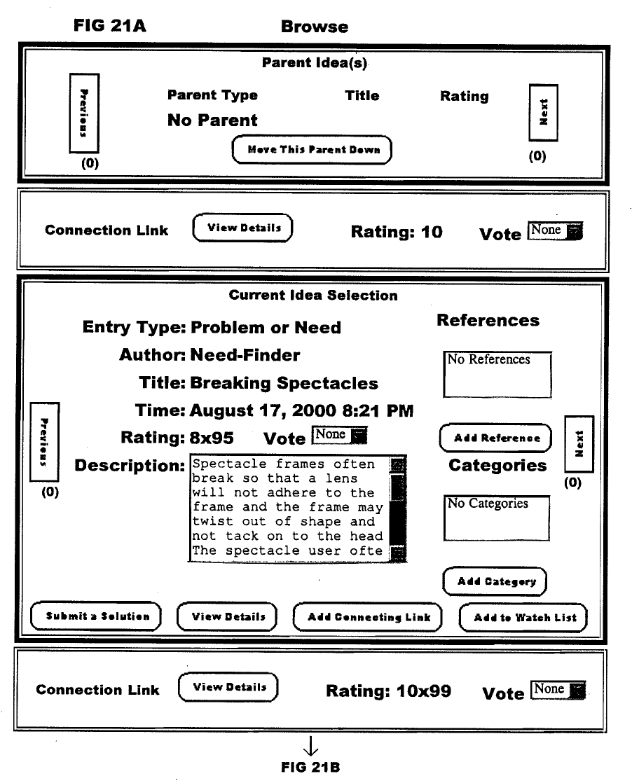

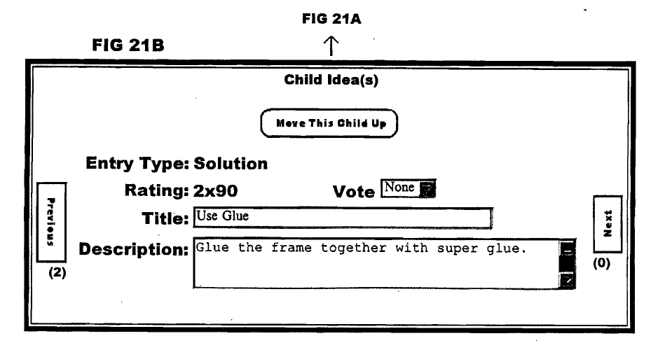

Clicking the Next button in the Child Idea(s) section of the screen display of FIG. 20 provides access to the screen display of FIG. 21, wherein the selected idea described in the Current Idea Selection section is Problem Idea 1, and the child idea described in the Child Idea(s) section is Solution Idea 2, as described above with reference to FIG. 2.

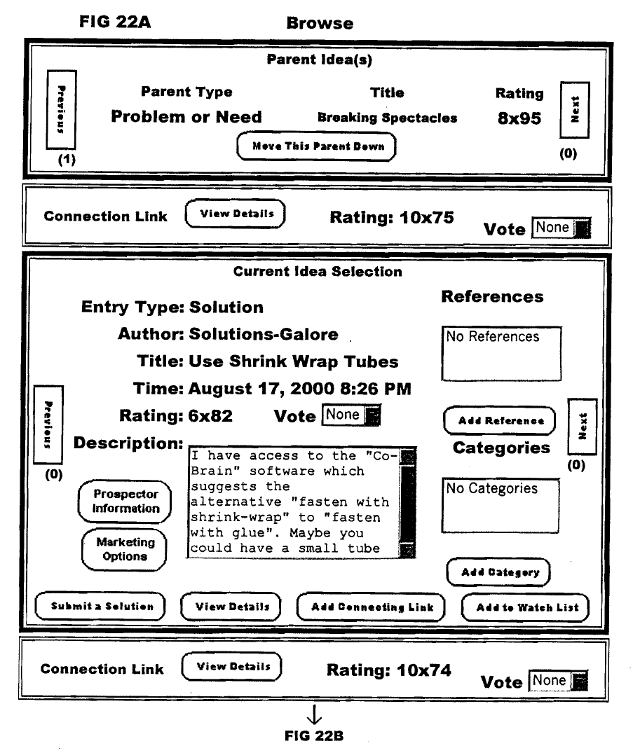

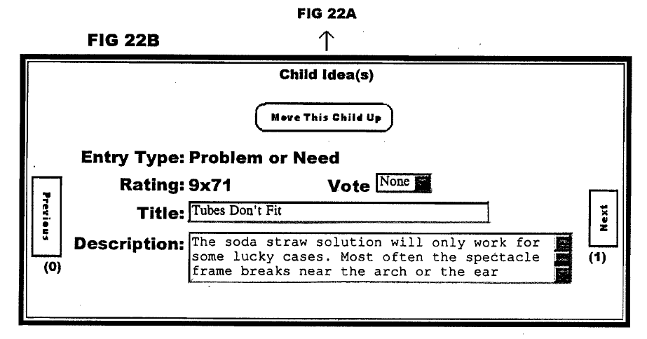

After returning to the initial screen display of FIG. 19, a screen display (as shown in FIG. 22), in which the child idea in the Child Idea(s) section of the screen display of FIG. 19 is displayed as the selected idea in the Current Idea Selection section, is accessed by clicking the “Move This Child Up” button in the Child Idea(s) section, in the screen display of FIG. 19.

In the screen display of FIG. 22, the selected idea described in the Current Idea Selection section is Solution Idea 6, the parent idea listed in the Parent section is Problem Idea 1, and the child idea described in the Child Idea(s) section is Problem Idea 7, as described above with reference to FIG. 2. In the Child Idea(s) section, the “(1)” indication beneath the Next button indicates that there is one other child idea linked to selected Solution Idea 6.

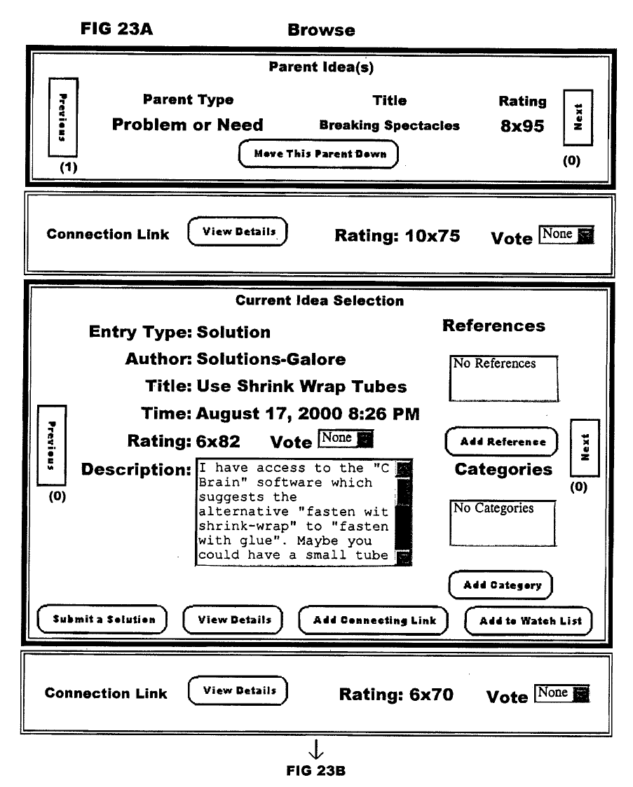

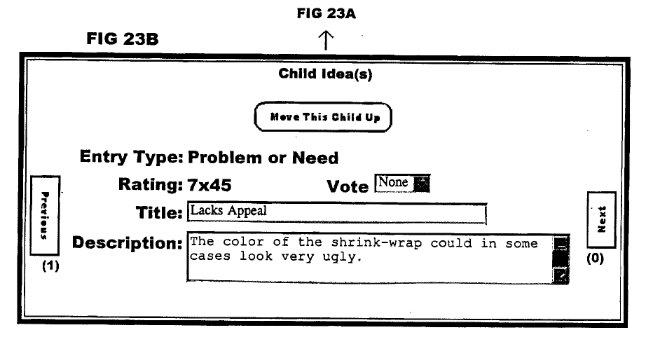

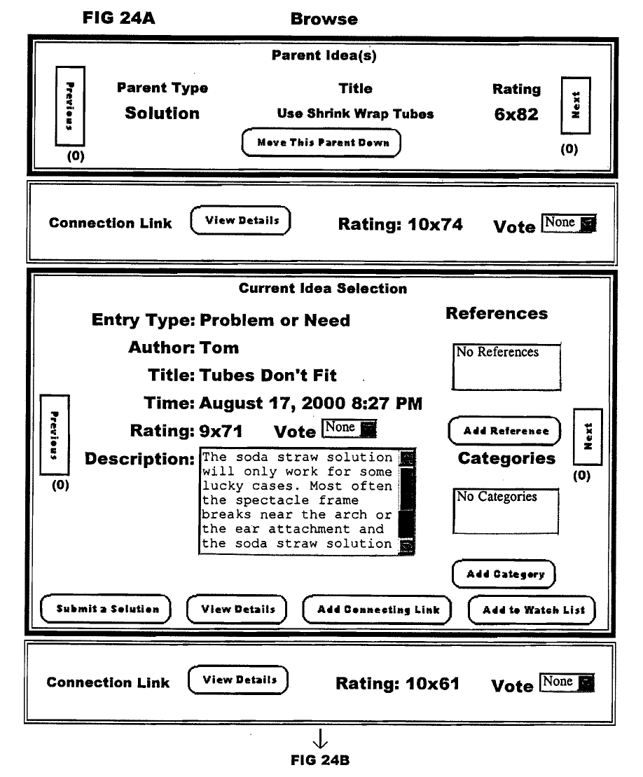

Clicking the Next button in the Child Idea(s) section of the screen display of FIG. 22 provides access to the screen display of FIG. 23, wherein the selected idea described in the Current Idea Selection section is Solution Idea 6, the parent idea listed in the Parent section is Problem Idea 1, and the child idea described in the Child Idea(s) section is Problem Idea 9, as described above with reference to FIG. 2.

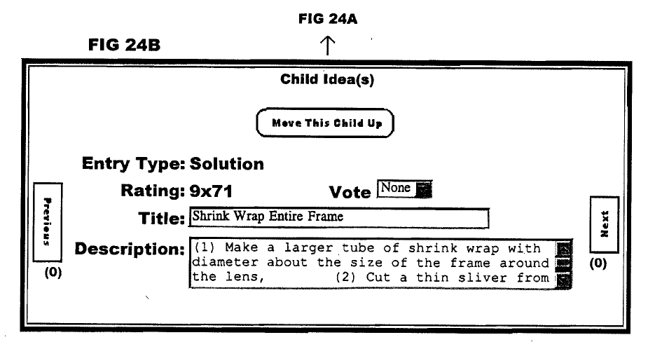

After returning to the screen display of FIG. 22, a screen display (as shown in FIG. 24), in which the child idea in the Child Idea(s) section of the screen display of FIG. 22 is displayed as the selected idea in the Current Idea Selection section, is accessed by clicking the “Move This Child Up” button in the Child Idea(s) section, in the screen display of FIG. 22.

In the screen display of FIG. 24, the selected idea described in the Current Idea Selection section is Problem Idea 7, the parent idea listed in the Parent section is Solution Idea 6, and the child idea described in the Child Idea(s) section is Solution Idea 8, as described above with reference to FIG. 2. In the Child Idea(s) section, the “(0)” indication beneath the Next button indicates that there are no other child ideas linked to selected Problem Idea 7.

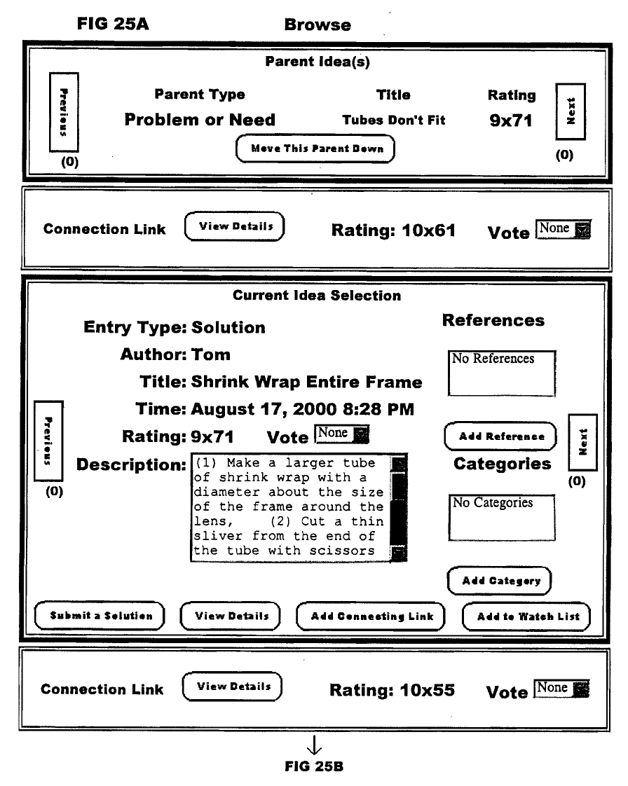

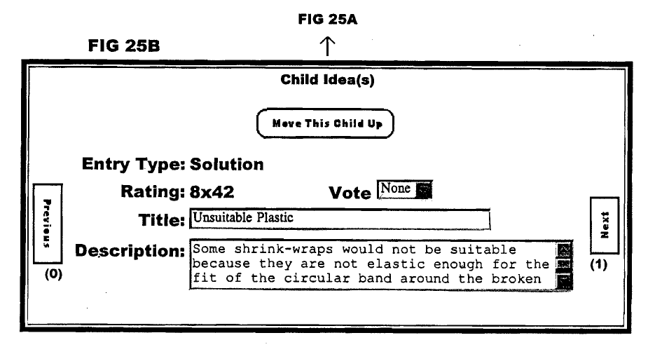

A screen display (as shown in FIG. 25), in which the child idea in the Child Idea(s) section of the screen display of FIG. 24 is displayed as the selected idea in the Current Idea Selection section, is accessed by clicking the “Move This Child Up” button in the Child Idea(s) section, in the screen display of FIG. 24.

In the screen display of FIG. 25, the selected idea described in the Current Idea Selection section is Solution Idea 8, the parent idea listed in the Parent section is Problem Idea 7, and the child idea described in the Child Idea(s) section is Problem Idea 11, as described above with reference to FIG. 2. In the Child Idea(s) section, the “(1)” indication beneath the Next button indicates that there is one other child idea linked to selected Solution Idea 8.

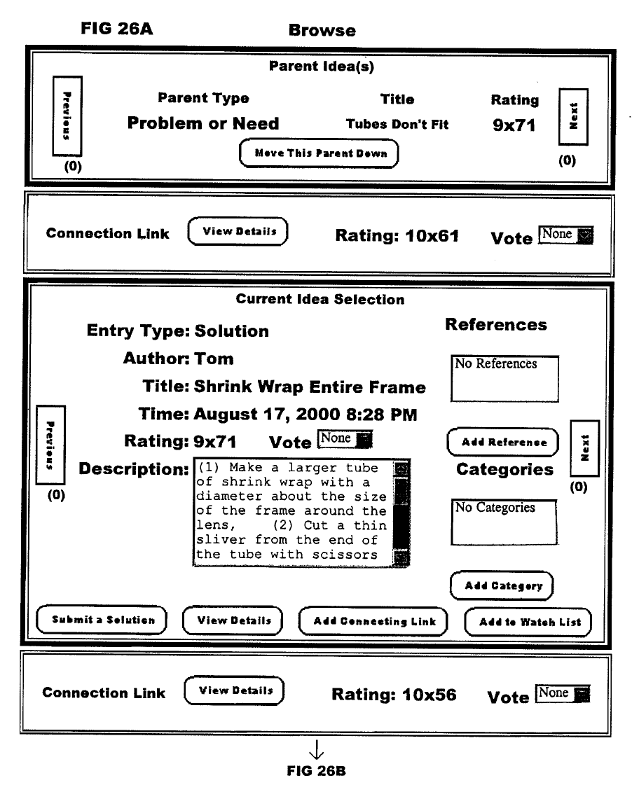

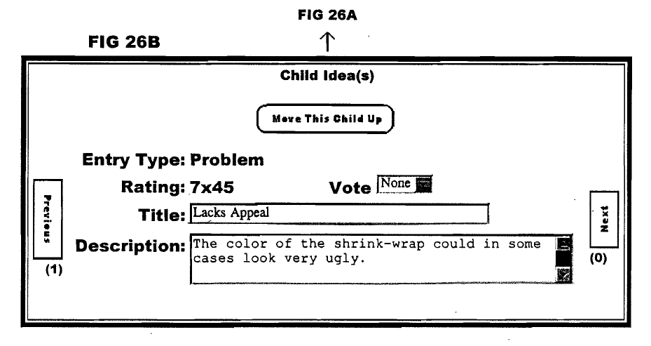

Clicking the Next button in the Child Idea(s) section of the screen display of FIG. 25 provides access to the screen display of FIG. 26, wherein the selected idea described in the Current Idea Selection section is Solution Idea 8, the parent idea listed in the Parent section is Problem Idea 7, and the child idea described in the Child Idea(s) section is Problem Idea 9, as described above with reference to FIG. 2.

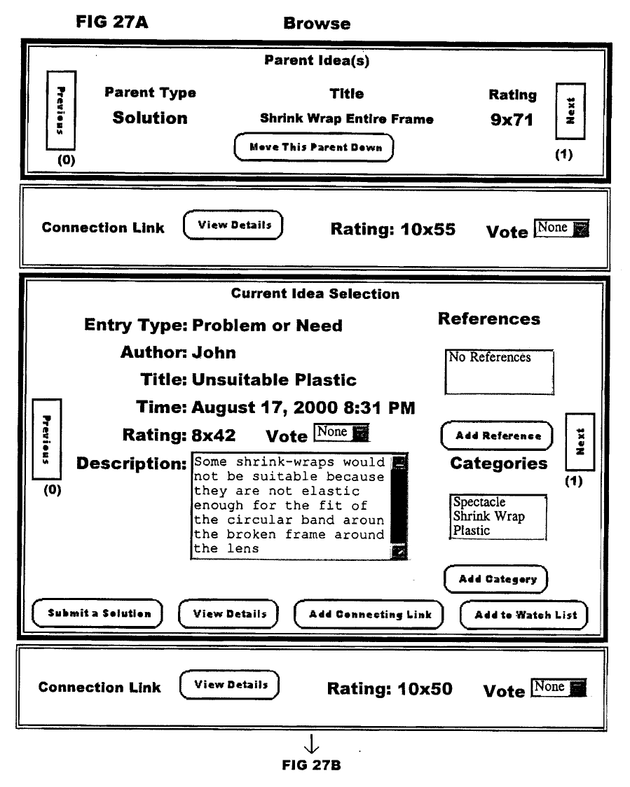

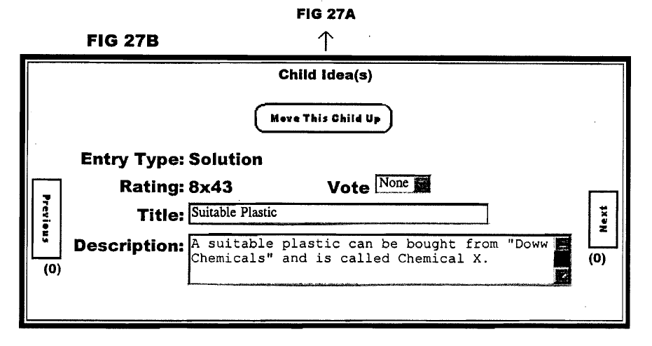

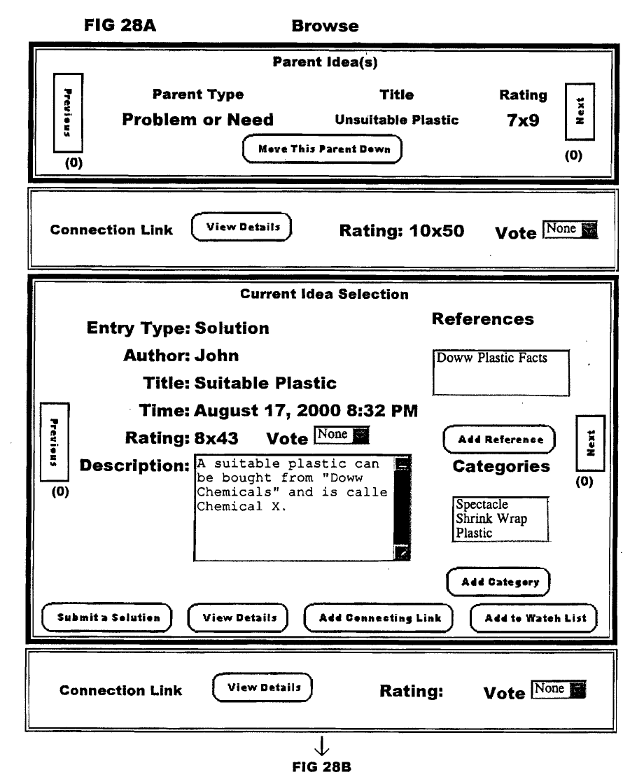

After returning to the screen display of FIG. 25, a screen display (as shown in FIG. 27), in which the child idea in the Child Idea(s) section of the screen display of FIG. 25 is displayed as the selected idea in the Current Idea Selection section, is accessed by clicking the “Move This Child Up” button in the Child Idea(s) section, in the screen display of FIG. 25.

In the screen display of FIG. 27, the selected idea described in the Current Idea Selection section is Problem Idea 11, the parent idea listed in the Parent section is Solution Idea 8, and the child idea described in the Child Idea(s) section is Solution Idea 12, as described above with reference to FIG. 2. In the Child Idea(s) section, the “(0)” indication beneath the Next button indicates that there are no other child ideas linked to selected Problem Idea 11.

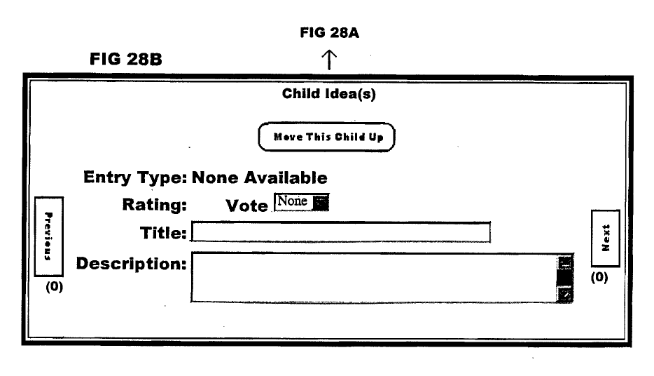

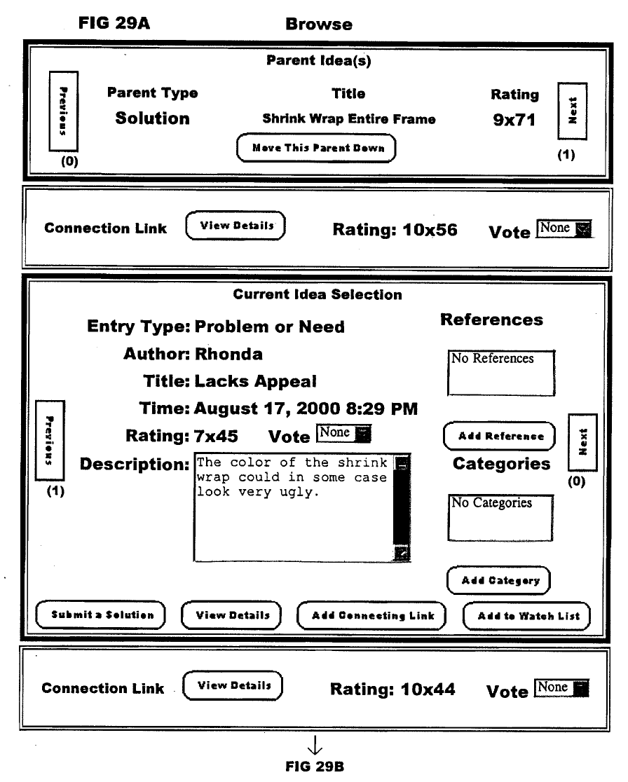

A screen display (as shown in FIG. 28), in which the child idea in the Child Idea(s) section of the screen display of FIG. 27 is displayed as the selected idea in the Current Idea Selection section, is accessed by clicking the “Move This Child Up” button in the Child Idea(s) section, in the screen display of FIG. 27.

In the screen display of FIG. 28, the selected idea described in the Current Idea Selection section is Solution Idea 12, the parent idea listed in the Parent section is Problem Idea 11, and no child idea described in the Child Idea(s) section.

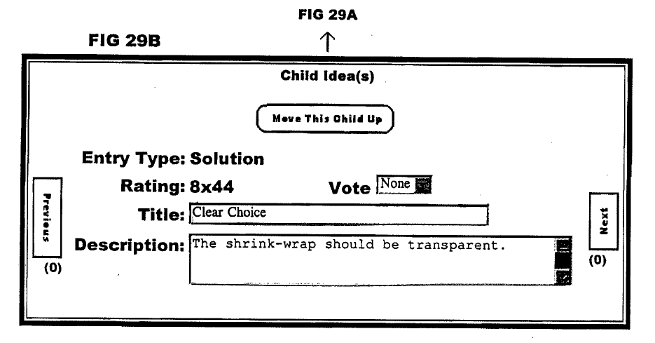

After returning to the screen display of FIG. 26, a screen display (as shown in FIG. 29), in which the child idea in the Child Idea(s) section of the screen display of FIG. 26 is displayed as the selected idea in the Current Idea Selection section, is accessed by clicking the “Move This Child Up” button in the Child Idea(s) section, in the screen display of FIG. 26.

In the screen display of FIG. 29, the selected idea described in the Current Idea Selection section is Problem Idea 9, the parent idea listed in the Parent section is Solution Idea 8, and the child idea described in the Child Idea(s) section is Solution Idea 10, as described above with reference to FIG. 2. In the Child Idea(s) section, the “(0)” indication beneath the Next button indicates that there are no other child ideas linked to selected Problem Idea 9. In the Parent section, the “(1)” indication beneath the Next button indicates that there is one other parent idea linked to selected Problem Idea 9.

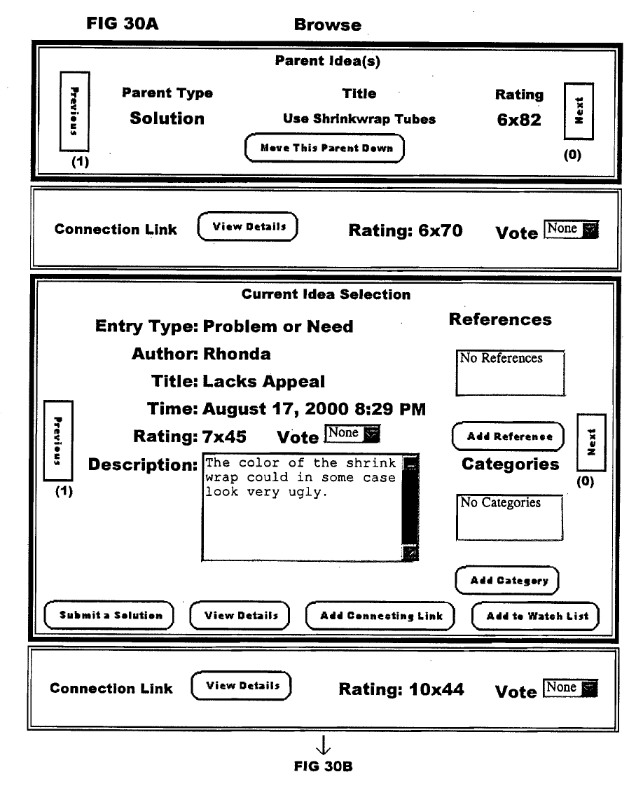

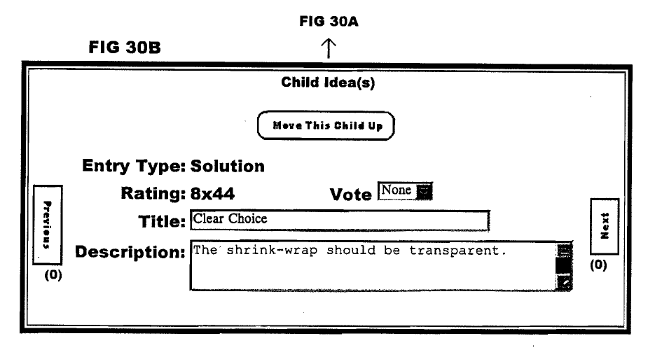

Clicking the Next button in the Parent section of the screen display of FIG. 29 provides access to the screen display of FIG. 30, wherein the selected idea described in the Current Idea Selection section is Problem Idea 9, the parent idea listed in the Parent section is Problem Idea 6, and the child idea described in the Child Idea(s) section is Solution Idea 10.

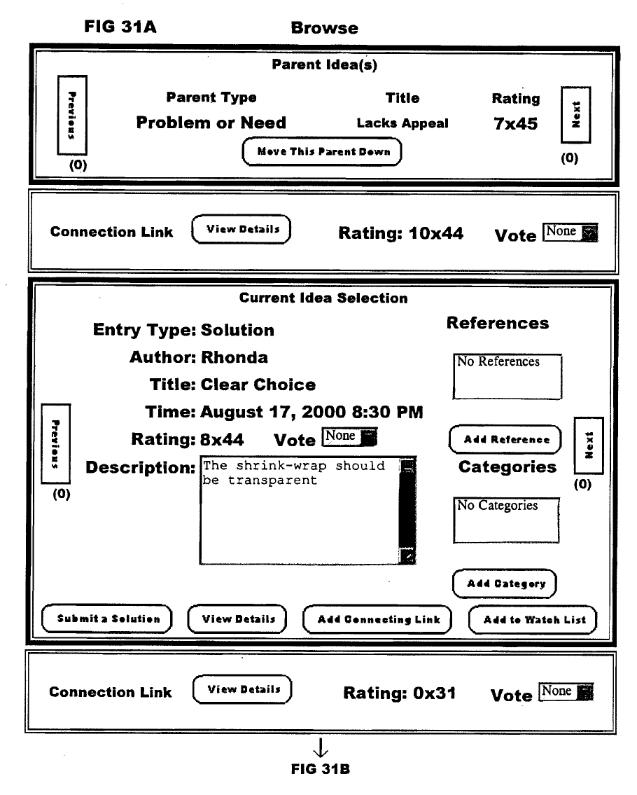

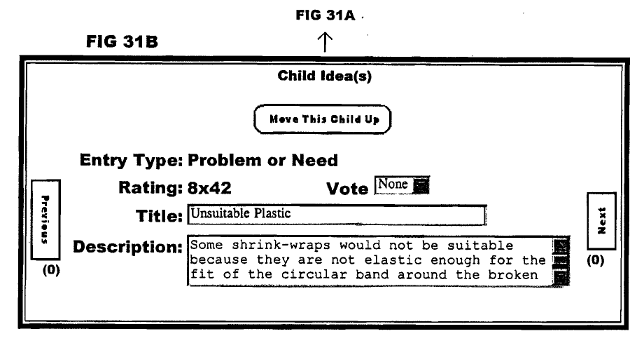

A screen display (as shown in FIG. 31), in which the child idea in the Child Idea(s) section of the screen display of FIG. 30 is displayed as the selected idea in the Current Idea Selection section, is accessed by clicking the “Move This Child Up” button in the Child Idea(s) section, in the screen display of FIG. 30.

In the screen display of FIG. 31, the selected idea described in the Current Idea Selection section is Solution Idea 10, the parent idea listed in the Parent section is Problem Idea 9, and the child idea described in the Child Idea(s) section is Problem Idea 11.

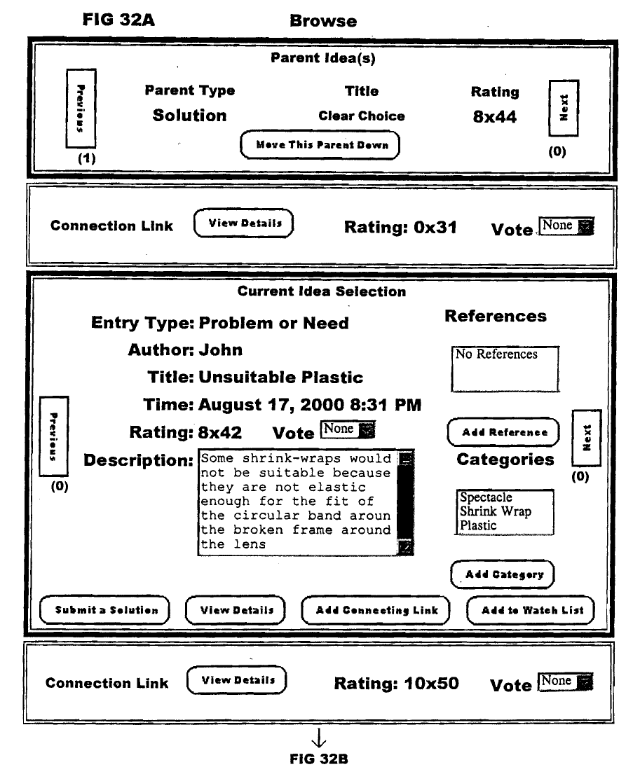

A screen display (as shown in FIG. 32), in which the child idea in the Child Idea(s) section of the screen display of FIG. 31 is displayed as the selected idea in the Current Idea Selection section, is accessed by clicking the “Move This Child Up” button in the Child Idea(s) section, in the screen display of FIG. 31.

In the screen display of FIG. 32, the selected idea described in the Current Idea Selection section is Problem Idea 11, the parent idea listed in the Parent section is Solution Idea 10, and the child idea described in the Child Idea(s) section is Solution Idea 12.

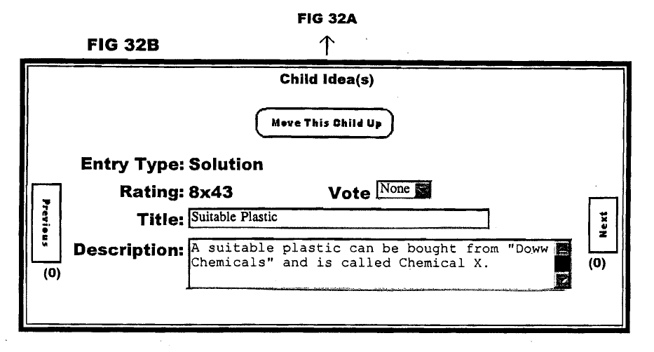

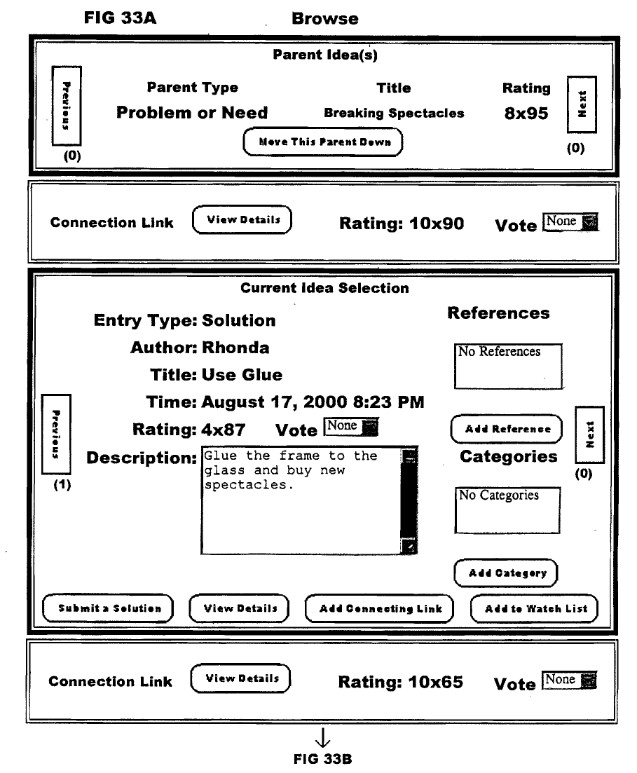

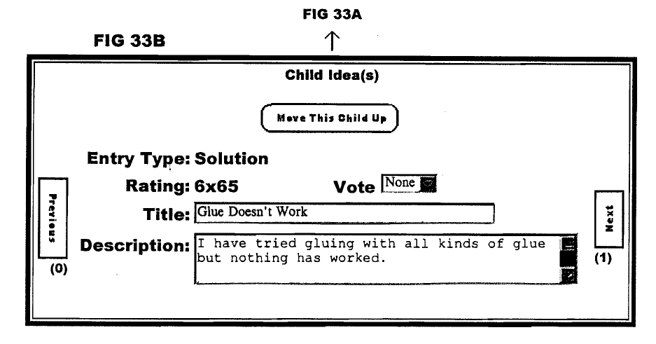

After returning to the screen display of FIG. 20, a screen display (as shown in FIG. 33), in which the child idea in the Child Idea(s) section of the screen display of FIG. 20 is displayed as the selected idea in the Current Idea Selection section, is accessed by clicking the “Move This Child Up” button in the Child Idea(s) section, in the screen display of FIG. 20.

In the screen display of FIG. 33, the selected idea described in the Current Idea Selection section is Solution Idea 3, the parent idea listed in the Parent section is Problem Idea 1, and the child idea described in the Child Idea(s) section is Problem Idea 4, as described above with reference to FIG. 2. In the Child Idea(s) section, the “(1)” indication beneath the Next button indicates that there is one other child idea linked to selected Solution Idea 3.

A screen display (as shown in FIG. 34), in which the child idea in the Child Idea(s) section of the screen display of FIG. 33 is displayed as the selected idea in the Current Idea Selection section, is accessed by clicking the “Move This Child Up” button in the Child Idea(s) section, in the screen display of FIG. 33.

In the screen display of FIG. 34, the selected idea described in the Current Idea Selection section is Problem Idea 4, the parent idea listed in the Parent section is Solution Idea 3, and no child idea described in the Child Idea(s) section.

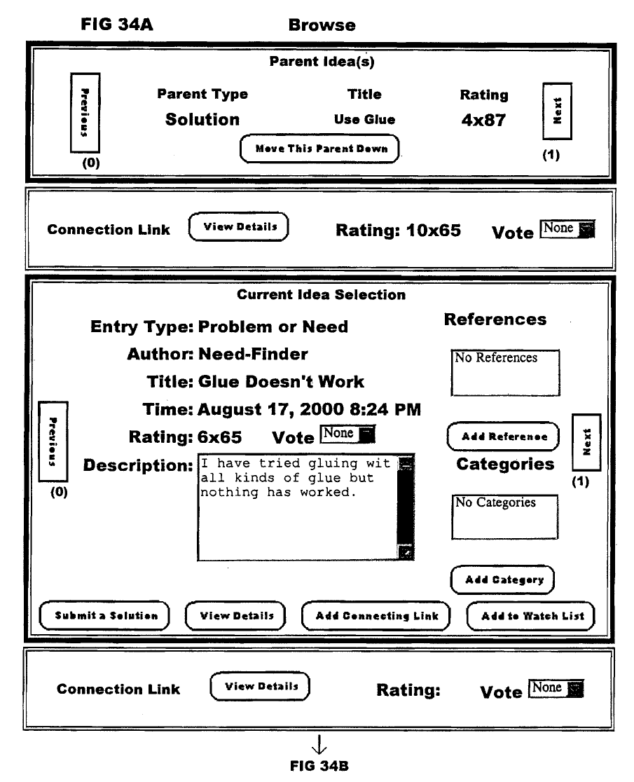

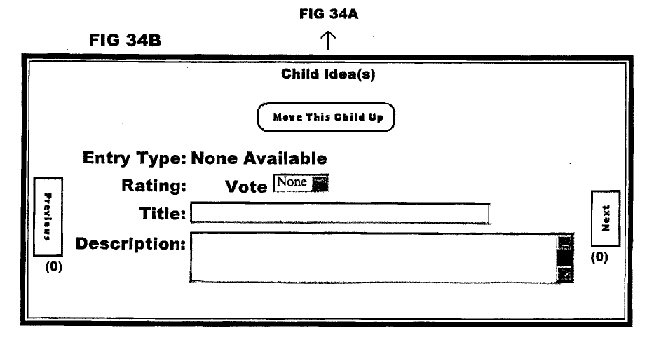

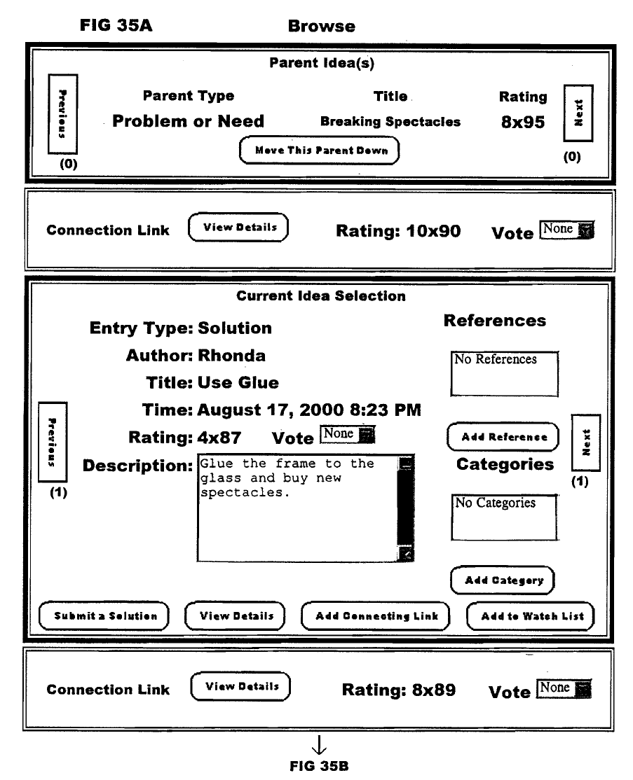

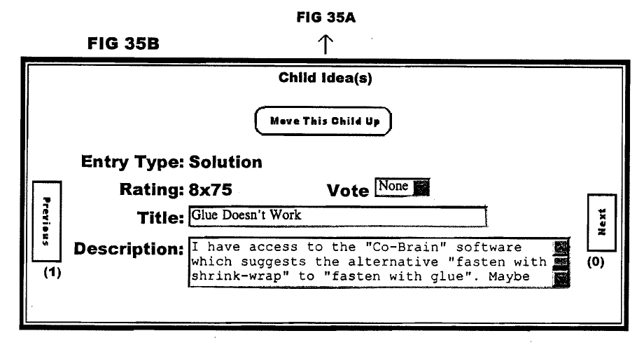

After returning to screen display of FIG. 33, clicking the Next button in the Child Idea(s) section of the screen display of FIG. 33 provides access to the screen display of FIG. 35, wherein the selected idea described in the Current Idea Selection section is Solution Idea 3, the parent idea listed in the Parent section is Problem Idea 1, and the child idea described in the Child Idea(s) section is Problem Idea 5, as described above with reference to FIG. 2.

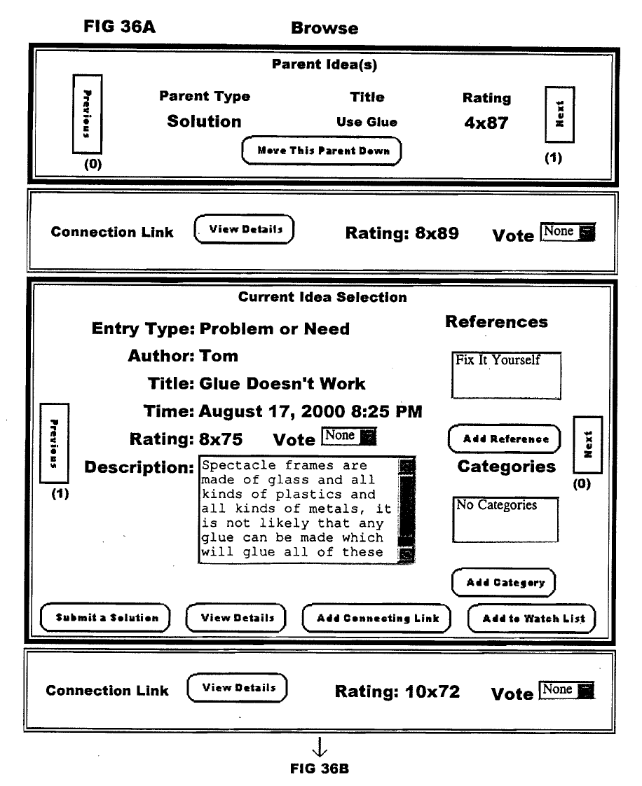

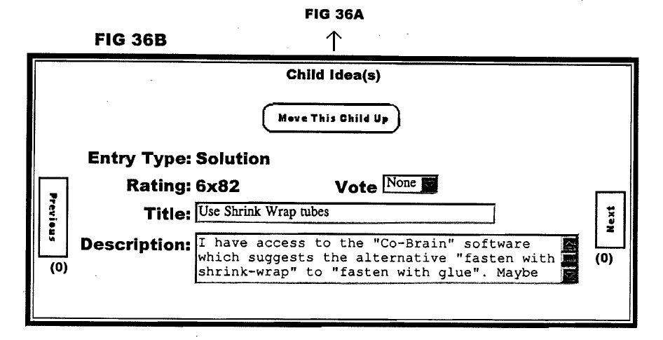

A screen display (as shown in FIG. 36), in which the child idea in the Child Idea(s) section of the screen display of FIG. 35 is displayed as the selected idea in the Current Idea Selection section, is accessed by clicking the “Move This Child Up” button in the Child Idea(s) section, in the screen display of FIG. 35.

In the screen display of FIG. 36, the selected idea described in the Current Idea Selection section is Problem Idea 5, the parent idea listed in the Parent section is Solution Idea 3, and Solution Idea 6 is child idea described in the Child Idea(s).

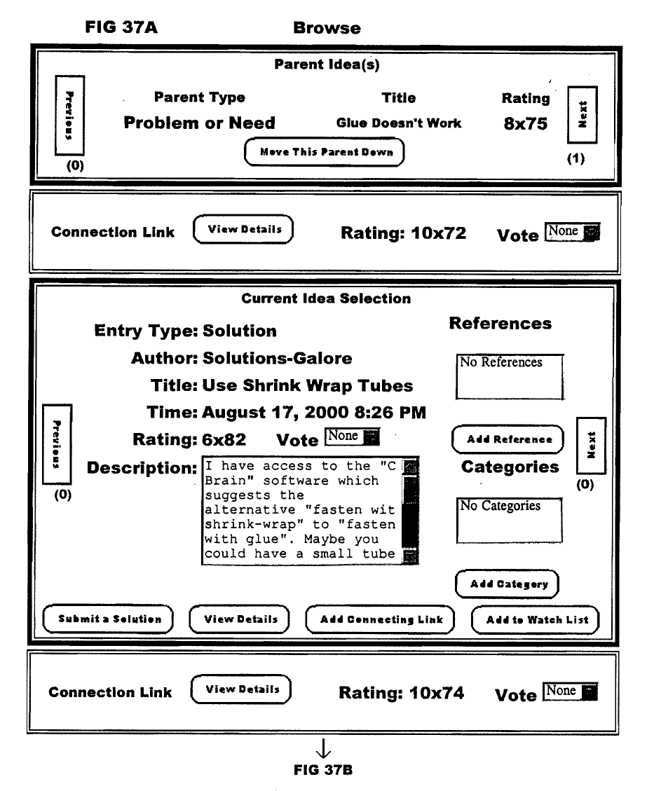

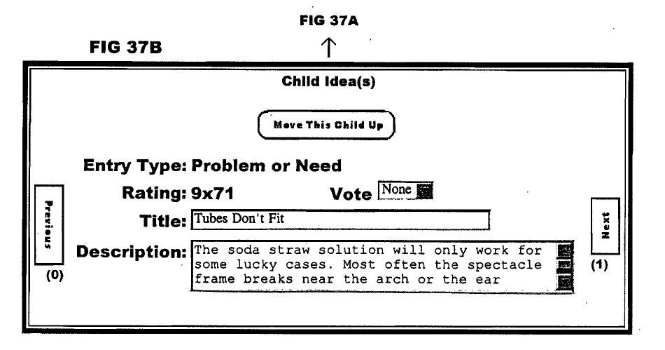

A screen display (as shown in FIG. 37), in which the child idea in the Child Idea(s) section of the screen display of FIG. 36 is displayed as the selected idea in the Current Idea Selection section, is accessed by clicking the “Move This Child Up” button in the Child Idea(s) section, in the screen display of FIG. 36.

In the screen display of FIG. 37, the selected idea described in the Current Idea Selection section is Solution Idea 6, the parent idea listed in the Parent section is Problem Idea 5, and the child idea described in the Child Idea(s) section is Problem Idea 7. In the Child Idea(s) section, the “(1)” indication beneath the Next button indicates that there is one other child idea linked to selected Solution Idea 6.

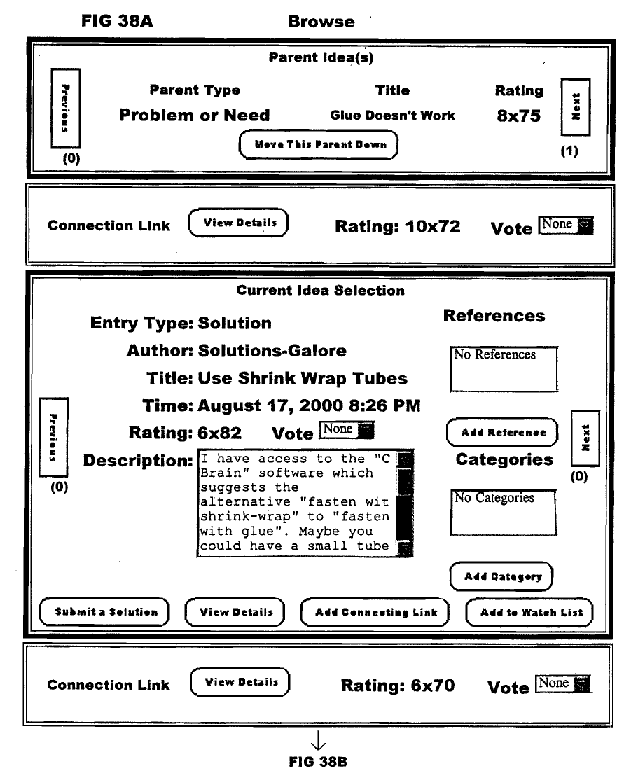

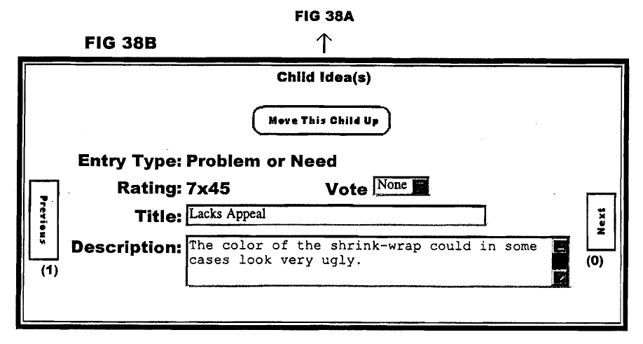

Clicking the Next button in the Child Idea(s) section of the screen display of FIG. 37 provides access to the screen display of FIG. 38, wherein the selected idea described in the Current Idea Selection section is Solution Idea 6, the parent idea listed in the Parent section is Problem Idea 5, and the child idea described in the Child Idea(s) section is Problem Idea 9.

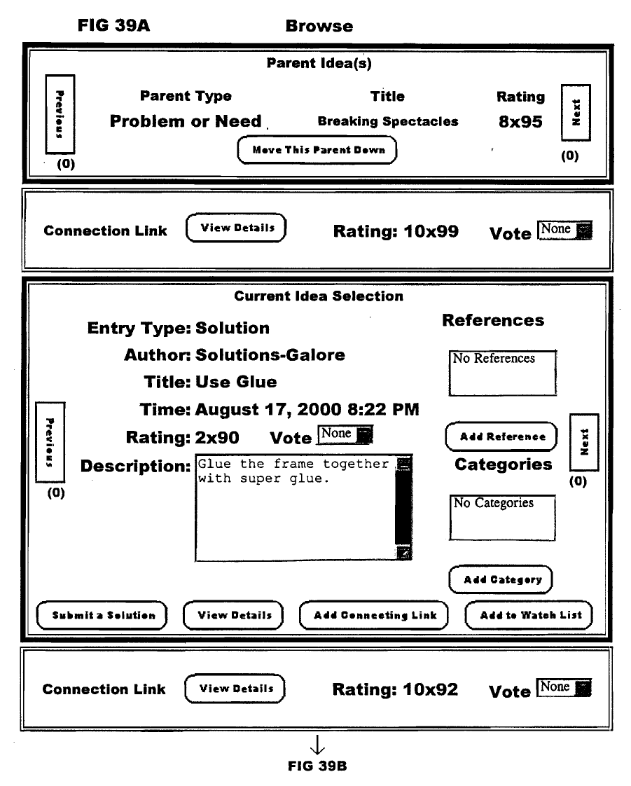

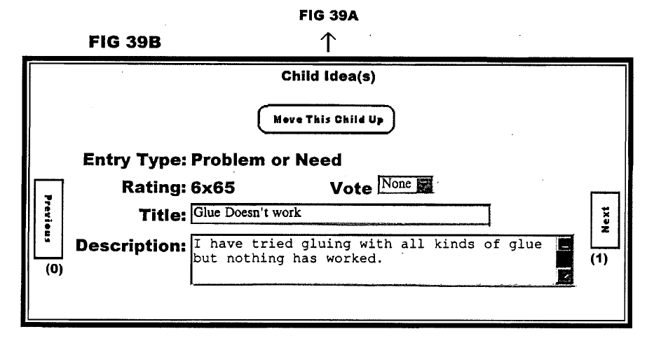

After returning to the screen display of FIG. 21, a screen display (as shown in FIG. 39), in which the child idea in the Child Idea(s) section of the screen display of FIG. 21 is displayed as the selected idea in the Current Idea Selection section, is accessed by clicking the “Move This Child Up” button in the Child Idea(s) section, in the screen display of FIG. 21.

In the screen display of FIG. 39, the selected idea described in the Current Idea Selection section is Solution Idea 2, the parent idea listed in the Parent section is Problem Idea 1, and the child idea described in the Child Idea(s) section is Problem Idea 4. In the Child Idea(s) section, the “(1)” indication beneath the Next button indicates that there is one other child idea linked to selected Solution Idea 2.

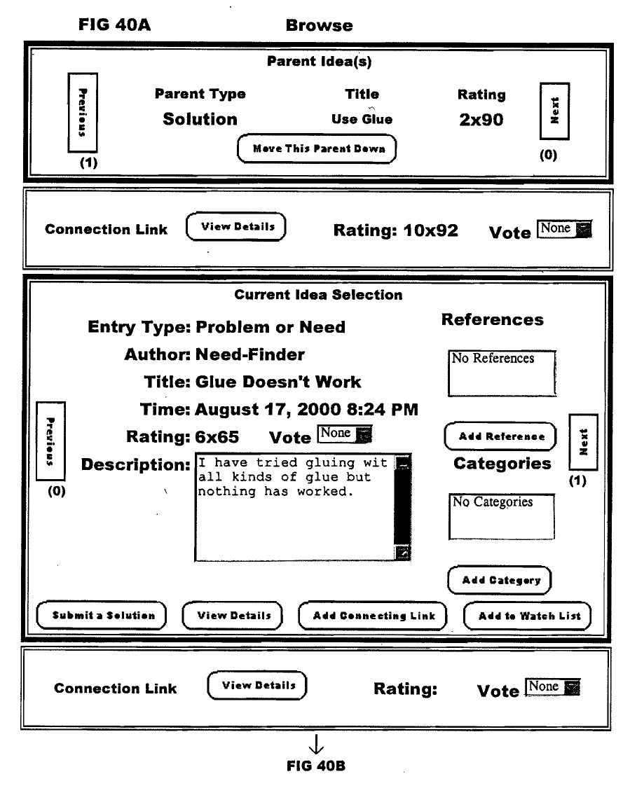

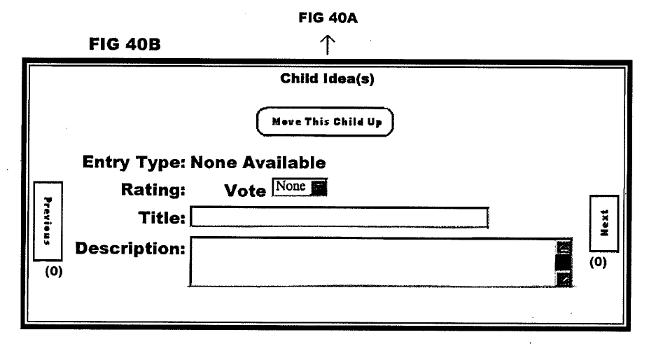

A screen display (as shown in FIG. 40), in which the child idea in the Child Idea(s) section of the screen display of FIG. 39 is displayed as the selected idea in the Current Idea Selection section, is accessed by clicking the “Move This Child Up” button in the Child Idea(s) section, in the screen display of FIG. 39.

In the screen display of FIG. 40, the selected idea described in the Current Idea Selection section is Problem Idea 4, the parent idea listed in the Parent section is Solution Idea 2, and no child idea described in the Child Idea(s) section.

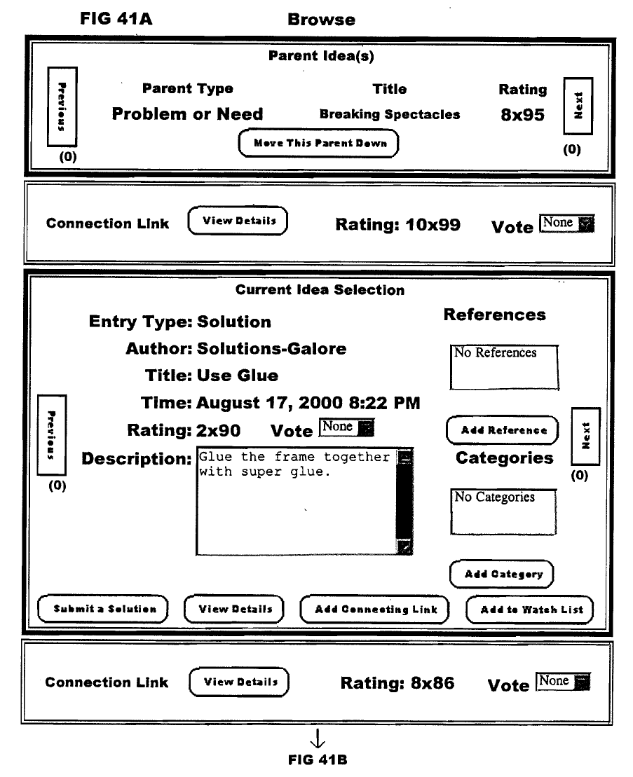

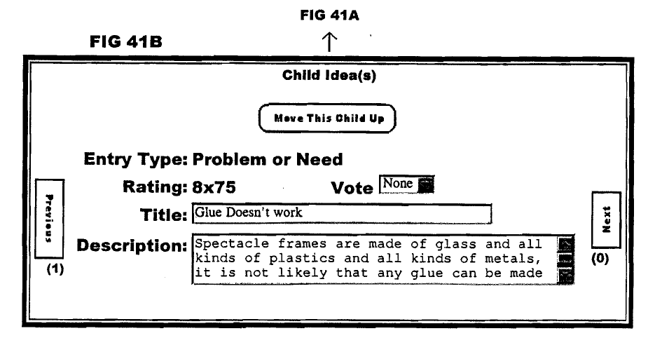

After returning to screen display of FIG. 39, clicking the Next button in the Child Idea(s) section of the screen display of FIG. 39 provides access to the screen display of FIG. 41, wherein the selected idea described in the Current Idea Selection section is Solution Idea 2, the parent idea listed in the Parent section is Problem Idea 1, and the child idea described in the Child Idea(s) section is Problem Idea 5.

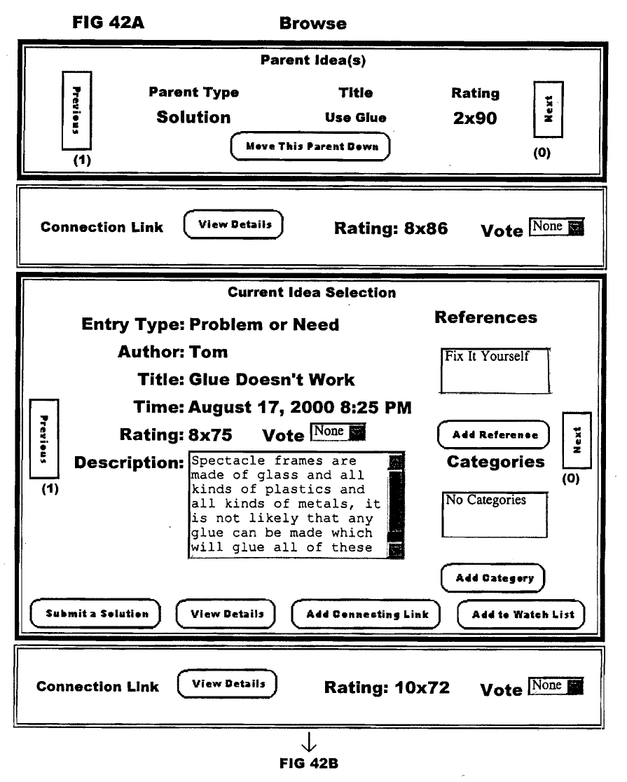

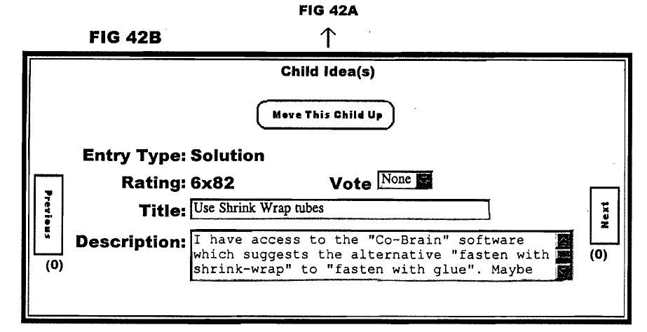

A screen display (as shown in FIG. 42), in which the child idea in the Child Idea(s) section of the screen display of FIG. 41 is displayed as the selected idea in the Current Idea Selection section, is accessed by clicking the “Move This Child Up” button in the Child Idea(s) section, in the screen display of FIG. 41.

In the screen display of FIG. 42, the selected idea described in the Current Idea Selection section is Problem Idea 5, the parent idea listed in the Parent section is Solution Idea 2, and the child idea described in the Child Idea(s) section is Solution Idea 6.

In the same manner, clicking the “Parent down” button moves the display of the parent down into the Current Idea Selection section.

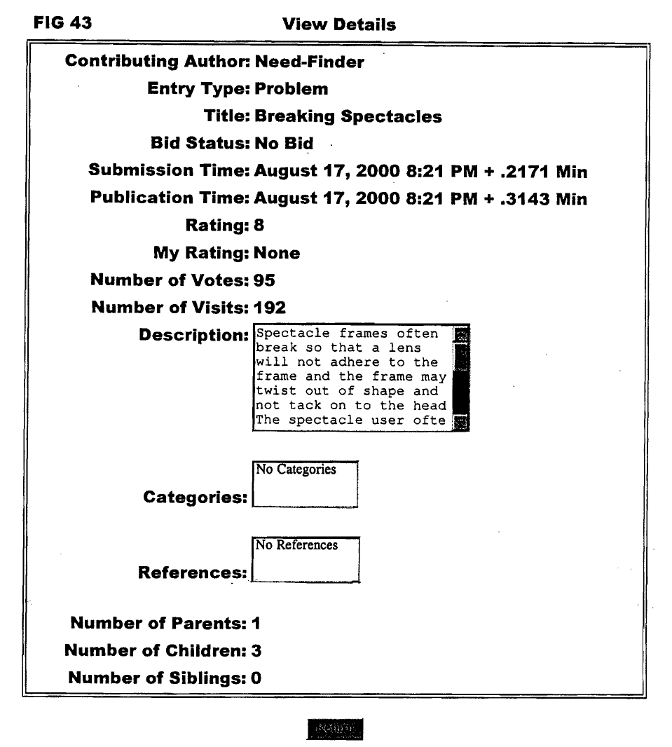

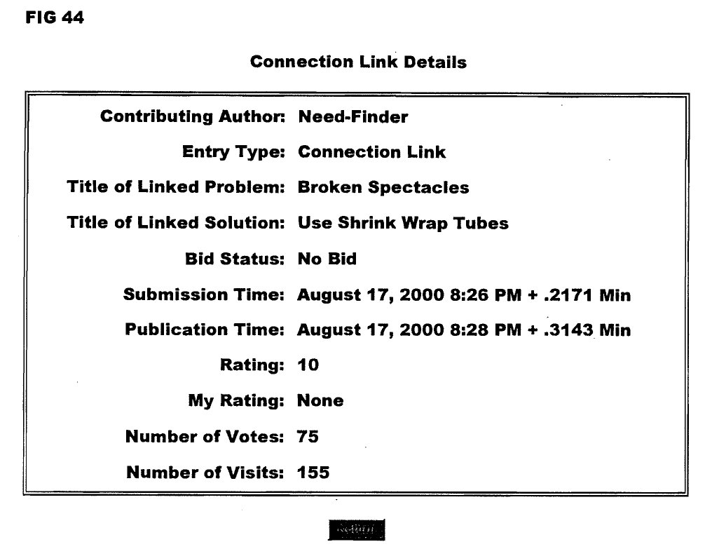

Referring again to the format of the screen display for a selected idea, as shown in FIG. 19, clicking the View Details button in the Current Idea Selection section provides access to the screen display of FIG. 43, which recites various details related to the selected idea in the Current Idea Selection section; and clicking the View Details button in the Connection Link section between the Current Idea Selection section and the Child Idea(s) section provides access to the screen display of FIG. 44, which recites various details related to the connection link between the current idea selection and the idea in the Child Idea(s) section

The Publish an Idea screen display of FIG. 12 includes an upper section for describing a first idea, a lower section for describing a second idea and a Connection Link section. The first idea is linked to the second idea unless the link is removed by clicking the “Remove this Link” button in the Connection link section. The display in the upper section corresponds to the Current Idea Selection section of a browse-mode display screen, such as shown in FIG. 19. Text is manually entered into the Title and Description portions of the lower section. The entered text may be added to a queue for submission with other entries by clicking the Add to Queue button in the lower section.

The queue is a storage area of scratch book for members of the Idea Space website to store and organize sets of contributed ideas and sets of connection links before they are submitted to the Idea Space database. Contributed ideas and connecting links may then be submitted as a unit in a member-organized configuration. Connection links within the queue may connect two contributed ideas within the queue, two currently published contributed ideas within the database, or a contributed idea within the queue and a currently published contributed idea within the database. Until submitted to the database individually or as a part of a unit in a member-organized configuration, the idea files in the queue and/or their organization within one or more units, as defined by their connection links, may be modified, deleted, moved, or recombined by the user/member. New contributed ideas and connection links may be added to the queue. Means are provided for selecting contributed ideas and connection links for submission to the database as an organized unit or individually. Submission to the database is not limited by the order in which the contributed ideas and the connection links are created. Contributed ideas and connection links in the queue that are not submitted when other contributed ideas and connection links in the queue are submitted are saved for later manipulation and/or submission to the idea database. The computer system managing the Idea Space website database does not process or publish contributed ideas or related connection links until the entire unit containing the contributed ideas and the related connection links is submitted. Partially received units are treated in the same manner as a partially received contributed idea or a partially received connection link; and the same time of receipt is recorded for all of the contributed ideas and connection links that are submitted as part of a unit. Upon publication in the database, the same time of publication is listed for all of the contributed ideas and connection links that are submitted as part of a unit.

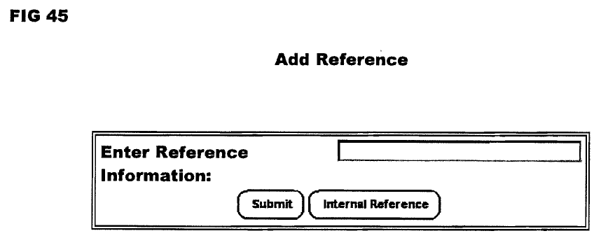

Referring again to the Publish an Idea screen display of FIG. 12, clicking the Add Reference button brings up the Add Reference screen display of FIG. 45, wherein an external reference may be identified by manually entering text in the Enter Reference Information space. Clicking the Submit button submits the identified external reference. If the user desires instead to enter an internal reference, the Internal Reference button is clicked.

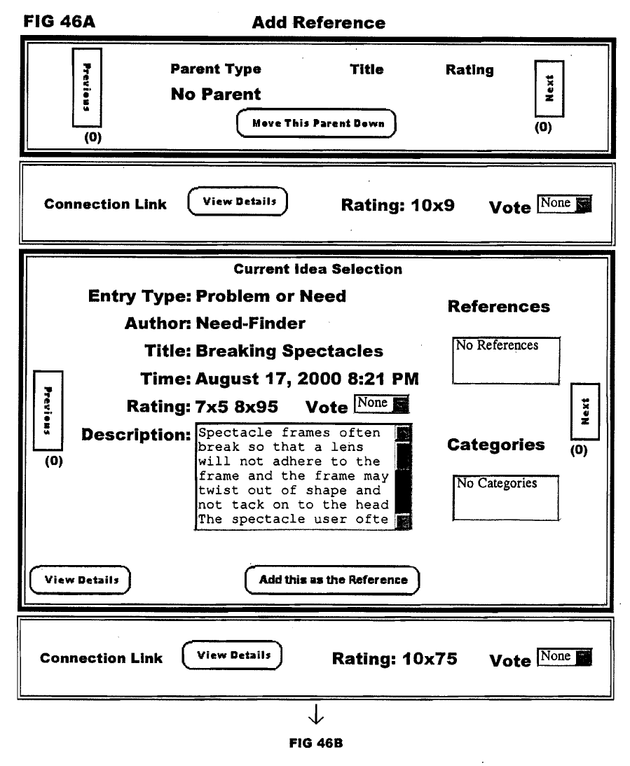

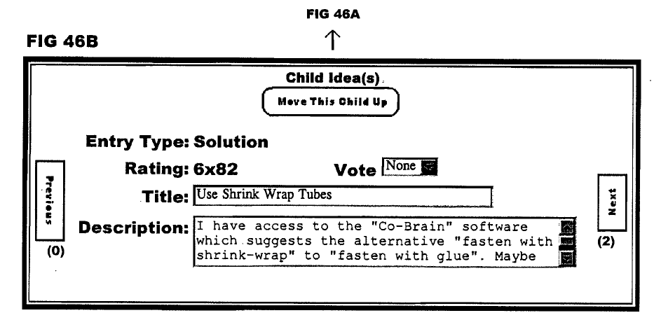

Clicking the Internal Reference button brings up the Add Reference screen display of FIG. 46, wherein a Current Idea Selection in the database, such as shown in the screen display of FIG. 19, may be accessed and added as a reference by selecting the desired contributed idea in the same manner as described above in describing the browse mode by clicking the “Add this as the reference” button.

Upon clicking the Add Categories button in the Publish an Idea screen display of FIG. 12, the user is enabled to select and add a category or categories from a list or lists of classes and subclasses of the United States Patent and Trademark Office and/or the Standard Industrial Classification (SIC) system to the respective idea file. If an appropriate class and/or subclass does not exist the user has the option of creating a new class and/or subclass. Other lists of classes may be used as a means for categorizing ideas and appropriate selection means are displayed to the user. Upon submission of the selected category or categories, selected category is associated with contributed idea described in the screen display from in which the Add Categories button is clicked.

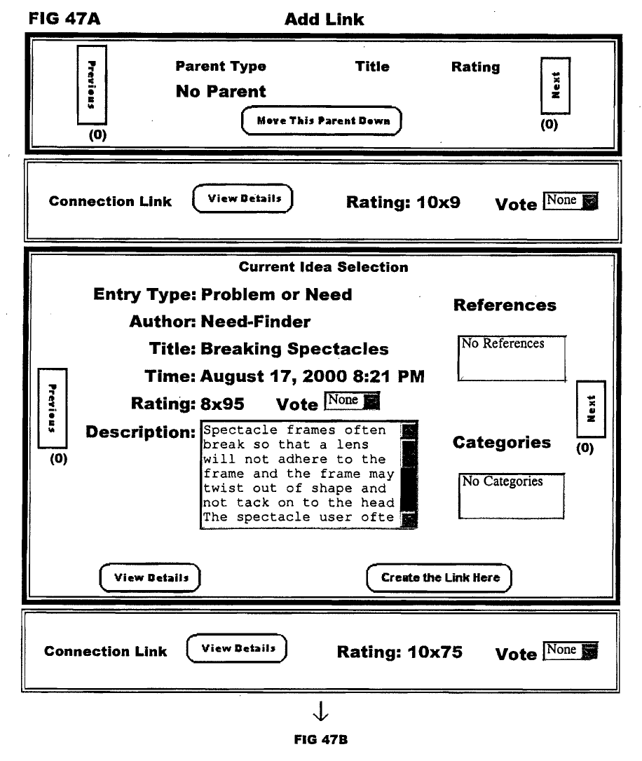

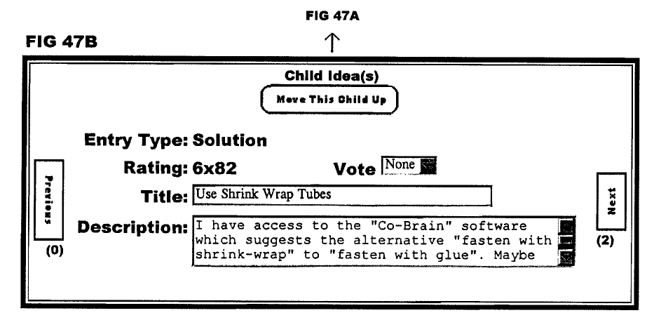

Clicking the Add Link button in the Publish an Idea screen display of FIG. 12 brings up the Add Link screen display of FIG. 47, wherein the Create the Link Here button is clicked to create the links shown in the Add Link screen display, after selecting the desired contributed idea in the same manner as described in describing the browse mode.

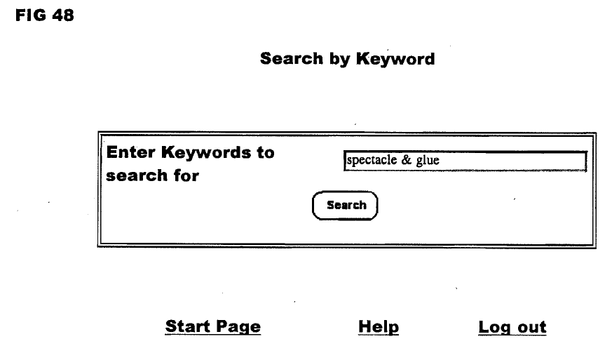

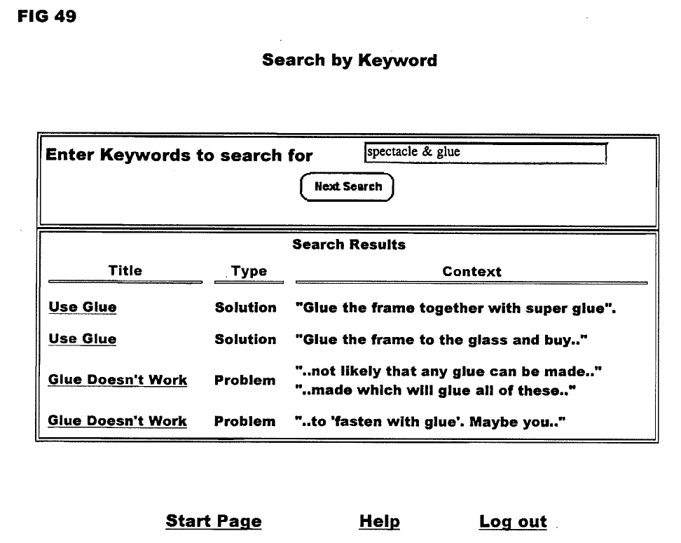

Referring to the Search for Contributions screen display of FIG. 13, clicking the Search by Keywords link brings up the screen display of FIG. 48. Clicking the search button in the screen display of FIG. 48 brings up the search results as shown in the screen display of FIG. 49.

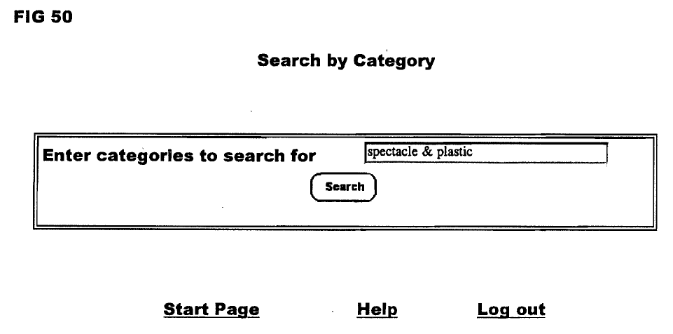

Clicking the Search by Categories link in the Search for Contributions screen display of FIG. 13 brings up the screen display of FIG. 50. Clicking the search button in the screen display of FIG. 50 brings up the search results as shown in the screen display of FIG. 51.

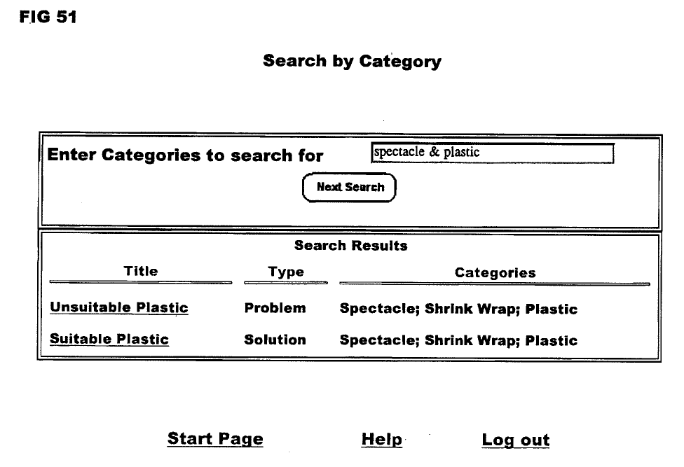

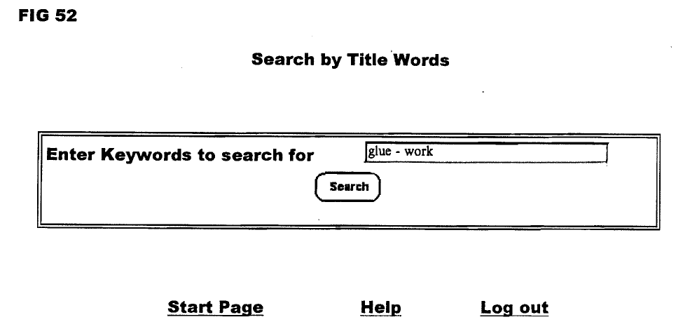

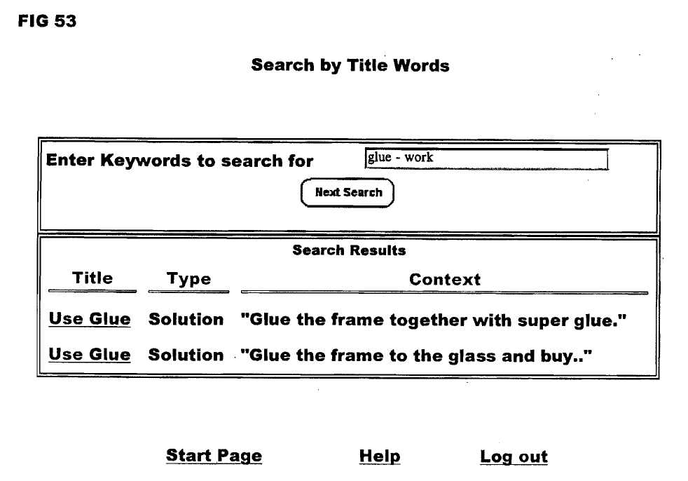

Clicking the Search by Title Words link in the Search for Contributions screen display of FIG. 13 brings up the screen display of FIG. 52. Clicking the search button in the screen display of FIG. 52 brings up the search results as shown in the screen display of FIG. 53.

Clicking the Advanced Search link in the Search for Contributions screen display of FIG. 13 enables a member user of the database to search the database for contributed ideas and/or connection links based on one or more sets of fields of their selection within the contributed files and/or connection links. The advanced search utilizes Boolean operators to logically combine together selections defined by key word entries within the same and different search fields. Wild cards are allowed for the key word entries in all fields.

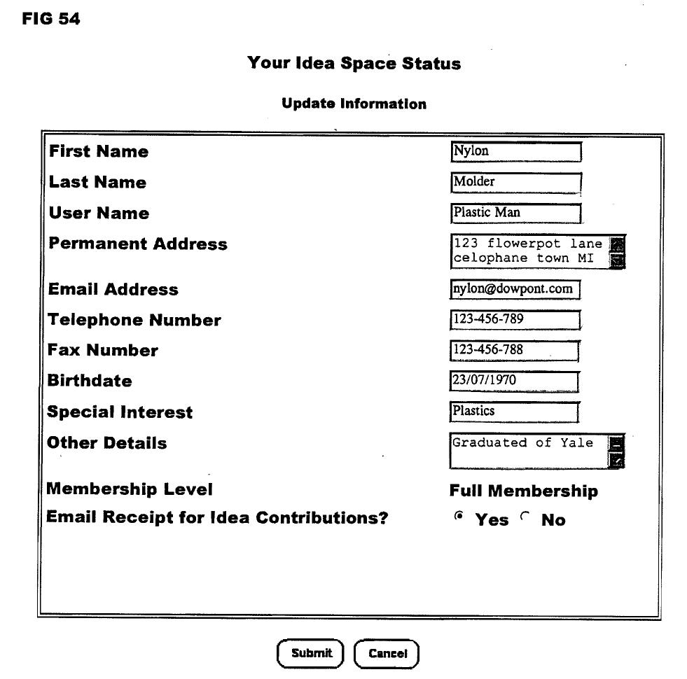

Clicking the Update Profile button in the Your Idea Space Status screen display of FIG. 18 brings up the screen display of FIG. 54. Note that the birth date of the user has been corrected in the screen display of FIG. 54.

In another preferred embodiment, the related ideas that are processed to provide an integrated idea in the database include contributed ideas of “problems with theories” and “solutions to problems with theories”. Preferably an integrated idea in accordance with this preferred embodiment is organized in the database by providing access links between contributed ideas of “problems with theories” and “solutions to problems with theories” and vice versa but generally not between contributed ideas of “problems with theories” and contributed ideas of “problems with theories” or between contributed ideas of “solutions to problems with theories” and contributed ideas of “solutions to problems with theories”. This preferred embodiment may have integrated ideas which are integrations of ideas of the other databases shown herein so that access links are preferably and generally created between contributed ideas of “solutions to problems with theories” and “problems with solutions and their enablement” and further between “problems with theories” and “solutions to problems and needs”. Alternatively such preferred embodiment may not be so integrated.

In the various embodiments of this invention the step of facilitating contribution of ideas to a computer database of ideas can be carried out automatically by the computer system. One example of such step being carried out automatically by a computer system would be as follows. In the exemplary embodiment described with reference to FIG. 2, where Idea 4 is contributed as a child of Idea 2 this step is accomplished by a human contributor; and where Idea 4 is contributed as a child of Idea 3, this latter contribution is accomplished automatically by a computer that is used to manage and provide the idea database in response to the computer recognizing the similarity of the words of Idea 2 and Idea 3. Such technology is known, and for example, is provided at http://www.cobrain.com. If an idea automatically contributed by a computer is inappropriate the idea will get a very low rating by the database users.

Another example of the step of facilitating contribution of ideas to a computer database of ideas being carried out automatically by a computer is as follows. Idea 10, which is based upon transparency, is contributed automatically by a computer owned and programmed by a member of the public in response to the computer recognizing the problem related to the word “color” in Idea 9. Such technology is also known, and for example, is provided at http://www.cobrain.com.

Another example of computer processing of ideas to provide an integrated idea is provided at website www.techoptimizer.com/products/Demo_Tech35/TO35 Demo.cfm, the disclosure of which is incorporated herein by reference thereto.

In some embodiments, the idea database 22 is maintained as a business by the idea manager 20, but is contributor and customer driven, in that some of the contributors 27 and some of the customers 28 suggest to the idea manager 20 when an idea is inappropriately located within the database 22 in relation to the search system. An idea file can be accessed by the search system by using a contributor identification code, a contributor-provided title; subject, keywords, time of entry into the database, time of publication (provision of access) on the database, time of first access of the idea entry, and/or the number of accesses to an idea entry. The time recordings are within an accuracy of one-one-hundredth or one-one-thousandth of a second. The search system is able to show a continuous listing of idea entries (files) in accordance with the time records.

In some embodiments, the time of entry into the database and the time of access from the database would be the same.

In some embodiments, the idea entries are never changed as a general rule, but may be repositioned in accordance with the search system.

In some preferred embodiments, the idea manager 20 systematically effects transfer of property rights to inventions 24 derived at least in part from the accumulated ideas to transferee customers, other than the contributors of the ideas from which the invention 24 was at least in part derived; and the computer system 21 is programmed to facilitate such transfers by on-line communications between the computer system 21 and the contributor computers 27 and/or the customer computers 28. Some such transfers that are pursuant to an obligation by the contributor to transfer such rights are to a transferee customer that was not identified upon establishment of said obligation.

In some preferred embodiments, the idea manager 20 systematically effects transfer of property rights 44 to inventions 24 derived at least in part from the accumulated ideas to itself 20 as the proprietor of the database 22 or to a party in concert with itself 20; and the computer system 21 is programmed to facilitate such transfers by on-line communications between the computer system 21 and the contributor computers 27 and/or the customer computers 28.

The transferred property rights 48 include rights to contributed ideas per se and/or at least some right under the patent rights to at least some of the inventions 24 derived at least in part from the ideas accumulated in the database 22, including both inventions derived from integrated contributed ideas and inventions innate to a single idea contributed by a single contributor.

Incident to facilitating transfer of such property rights 48, or independent of such transfer, the idea manager 20 (a) sells at least some right under the patent rights to at least some of the inventions 24; (b) auctions at least some right under the patent rights to at least some of the inventions 24; (c) brokers and/or markets at least some rights under the contingent contractual rights to at least some of the inventions 24; (d) acquires at least some right under the patent rights to at least some of the inventions 24; and/or (e) facilitates public sale of the acquired rights to at least some of the inventions 24. In the preferred embodiment, such sale, auction, brokering, marketing, acquisition and facilitation of public sale are performed systematically. In alternative embodiments one or more of such sale, auction, brokering, marketing, acquisition and facilitation of public sale are not performed systematically.

In some preferred embodiments, the computer system 21 is programmed to enable transfer of contingent contractual rights 40 in a marketable format between an owner of contingent property rights 40 and another interested party. One embodiment of such a marketable format is described in the About IDEA SHARES screen display shown in FIG. 55, which may be accessed by clicking the About Idea Shares link in the About IDEA SPACE screen display shown in FIG. 4B.

The contributor of an idea is generally assigned ownership of contingent contractual property rights 40 upon contribution of the idea in exchange for transfer of property rights 44, 48 to the idea manager 20 or some other transferee. However, the contributor may specify another party unto which to initially assign ownership of the contingent contractual rights 40, such as the employer of contributor.

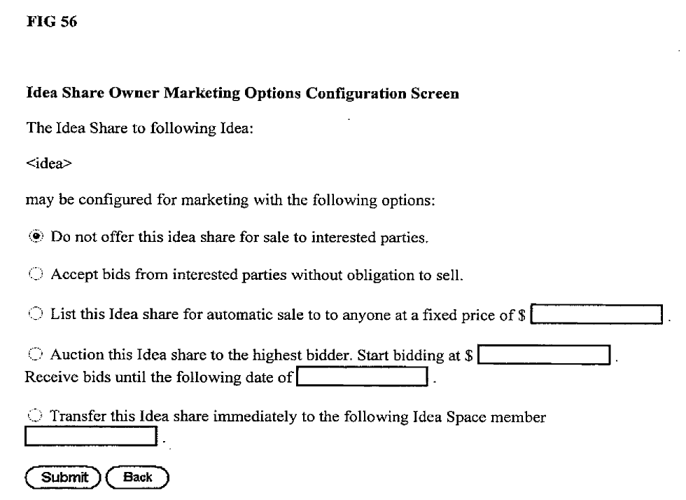

The current owner of a contingent contractual right 40 may elect, among other possible choices, to transfer, sell, or auction the contingent contractual rights 40 to other parties such as a party having a membership for the purpose of purchasing such contractual contingent rights 40. The computer system 21 is programmed to enable implementation of such choices by enabling only idea contributors whom own contingent contractual rights 40 to access an Idea Share Owner Marketing Options Configuration Screen display, such as shown in FIG. 56. Such access is effected by clicking a Marketing Options button in the Current Idea Section of a Solution type screen display, such as shown in FIG. 22A.

Depending upon which of the options shown in the screen display of FIG. 56 is selected and submitted, one of four different types of Idea Share Prospector Information Screen displays can be accessed when a person subsequently viewing the idea solution in the screen display of FIG. 22A clicks the Prospector Information button in the Current Idea Section of a Solution type screen display, such as shown in FIG. 22A.

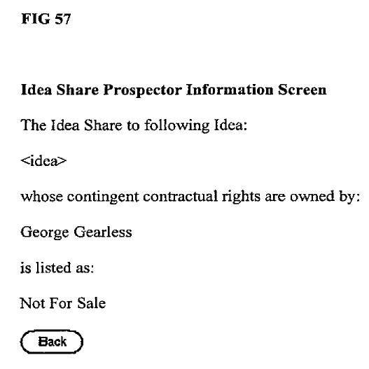

When the “Do not offer this idea share for sale to interested parties” option on the screen display of FIG. 56 has been selected and submitted, the Idea Share Prospector Information Screen display shown in FIG. 57 is displayed in response to clicking the Prospector Information button in the screen display of FIG. 22A.

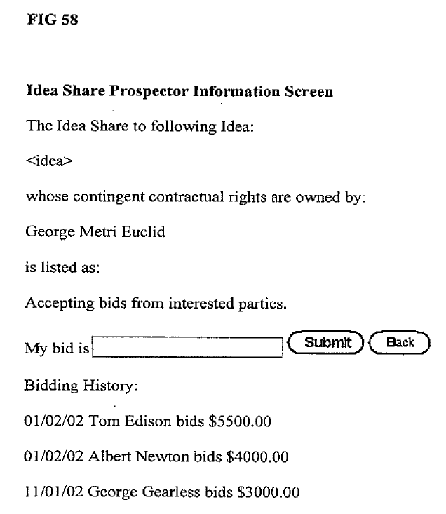

When the “Accept bids from interested parties without obligation to sell” option on the screen display of FIG. 56 has been selected and submitted, the Idea Share Prospector Information Screen display shown in FIG. 58 is displayed in response to clicking the Prospector Information button in the screen display of FIG. 22A.

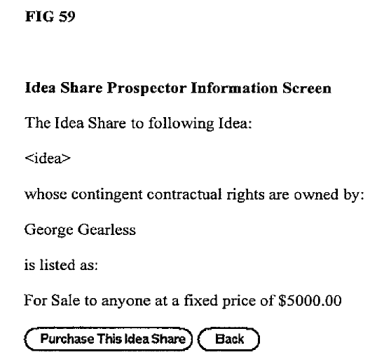

When the “List this Idea share for automatic sale to anyone at a fixed price” option on the screen display of FIG. 56 has been selected and submitted, the Idea Share Prospector Information Screen display shown in FIG. 59 is displayed in response to clicking the Prospector Information button in the screen display of FIG. 22A.

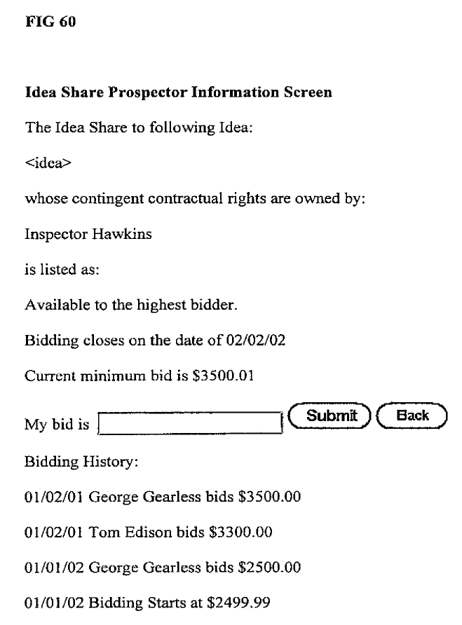

When the “Auction this Idea share to the highest bidder” option on the screen display of FIG. 56 has been selected and submitted, the Idea Share Prospector Information Screen display shown in FIG. 60 is displayed in response to clicking the Prospector Information button in the screen display of FIG. 22A. Bids submitted by use of the screen display of FIG. 60 are subsequently displayed in the Bidding History portion of such screen display.

Methods of selling contingent contractual rights 40 other than at a fixed price or auction also are enabled by the computer system 21, including combinations of the methods utilizing the screen displays of FIGS. 56-60, and such other methods may be based on other conditions provided by the idea manager 20, the owner of the contingent contractual rights or an interested party.

In the preferred embodiment, the idea manager 20 also systematically facilitates preparation and/or filing of patent applications for at least some of the unpatented inventions, as indicated at 50. Preferably, for some inventions, the step 48 of facilitating transfer of at least some right under the patent rights is carried out systematically before the step 50 of facilitating preparation and/or filing of a patent application. The computer system 21 is used to prepare and/or file a patent application for unpatented inventions innate to ideas in the database 22. Computer software for preparing patent applications from a database including an idea of an invention includes “Patent Pro” brand software available from Kernel Creations, Ltd. and “Patent Wizard” brand software available from Patent Wizard, LLC of Fargo, N. Dak. Computer software for filing patent applications in various national patent offices has been provided by the various national patent offices.

The idea manager 20 facilitates systematic filing of invention disclosure documents and/or patent applications disclosing some of the accumulated ideas that are new and/or related to accumulated ideas disclosed by previously filed disclosure documents and/or patent applications and accumulated in the computer database 22 subsequent to the filing of the previously filed disclosure documents and/or patent applications.

In some embodiments, a customer is enabled upon payment of a fee to file a first right of refusal to the property rights to a prospectively patentable invention. Such a filing can be accessed with the idea entry. Such rights may include contingent rights provided by the idea manager 20 and/or transferred property rights.

In some preferred embodiments the computer system 21 is programmed to publish the conditions for sale or license of property rights to at least some of the prospectively patentable inventions 24 in the database 22 and/or a history of sale or license of property rights to at least some of such inventions 24 by entering such conditions and history in the database 22 for public or member viewing. Examples of such conditions include: for sale, not for sale, will take bids, will sell to highest bidder before a specified date, will sell for a specified amount or to the highest bidder by a specified date. Examples of such a history include: sold to FSHP Company on a given date for a stated amount and licensed to General Plastics on a given date for a stated royalty.

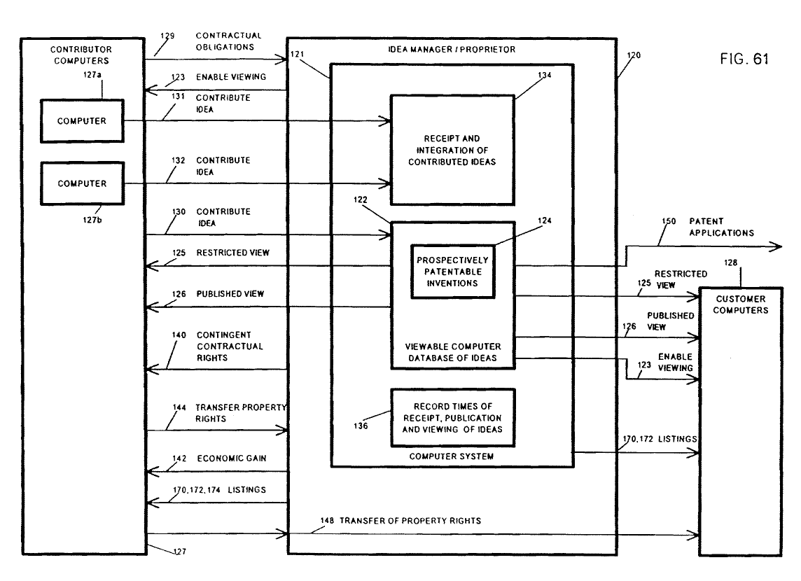

Referring to FIG. 61, in a preferred embodiment of the present invention, an idea manager 120 maintains a computer system 121 and a computer database 122 for accumulating ideas for prospectively patentable inventions. The accumulated ideas may include needs and requirements of such inventions and/or are systematically accumulated prior to filing any patent applications for inventions respectively derived at least in part from the accumulated ideas. The idea manager 120 is the proprietor of the idea database 122 and/or one or more parties operating in concert with the proprietor. The computer system 121 is adapted by hardware, firmware and/or software for performing and/or enabling performance of the various methods described herein.

Various embodiments of systems and methods of managing the ideas contributed to and accumulated in the idea database 122 are described in International Patent Application Publication No. WO 02/17143 A1, the disclosure of which is incorporated herein by reference thereto. Said disclosure is also contained in related U.S. patent application Ser. No. 10/019,155 filed Oct. 25, 2001.

The computer system 121 may include one or more computers and one or more memories contained within or coupled to the computer(s). The idea manager 120 may be one party or different parties operating in concert with one another. Idea contributors use computers 127 to view 125, 126 the ideas accumulated in the idea database 122. One idea contributor can be the idea manager 120, including its staff and/or its computer system 121. Some contributor computers 127 may be shared by a plurality of contributors. Potential customers for property rights, including patent rights, to prospectively patentable inventions 124 derived at least in part from the ideas accumulated in the idea database 122 use computers 128 to view 125, 126 the accumulated ideas in the idea database 122 when viewing is enabled 123 by the computer system 121. In some embodiments, the contributor computers 127 may be the same as the customer computers 128 and/or the computers of the computer system 121. Some viewings 125 of the ideas from the idea database 122 are so restricted by non-disclosure agreements by the viewers as not to constitute a publication of the ideas; and some viewings 126 of the ideas from the idea database 122 are enabled without restriction and thereby constitute a publication of the ideas.

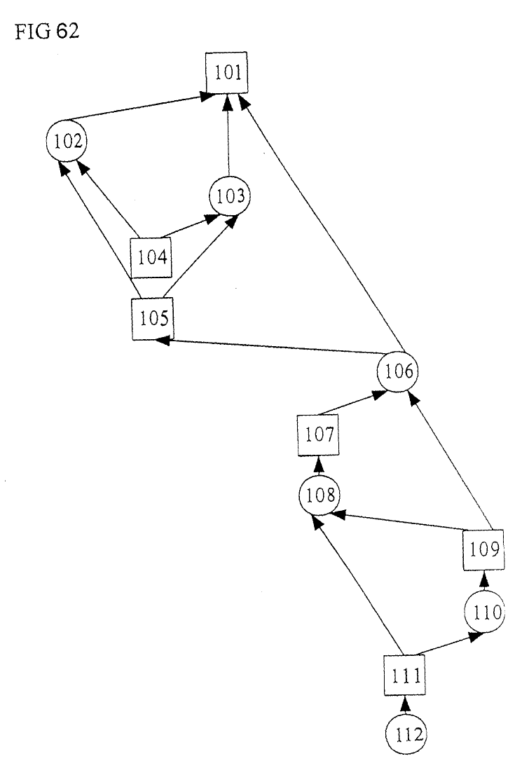

The computer system 121 is programmed to enable ideas contributed by one or more different contributors to the idea database 122 to be integrated by URL access links defined within the idea database 122 and contained in screen displays of the respective idea contributions to thereby produce idea trees that facilitate derivation of inventions 124 from the integrated ideas, as indicated at 134 in FIG. 61. For example, a first idea 131 contributed by a first member using the computer 127a is integrated with a second idea 132 contributed by a second member using the computer 127b to provide an integrated idea of a prospectively patentable invention 124. In another example, ideas contributed from the same computer by one or different contributors are integrated within the idea database 122. Alternative preferred embodiments of systems and methods for integrating invention ideas contributed to a computer database are described below with reference to FIGS. 62 through 66 and FIG. 67 respectively.

Still referring to FIG. 61, the computer system 121 is programmed by the idea manager 120 to facilitate use of the contributor computers 127 to make on-line contributions of ideas 131, 132 to the idea database 122. Computer programs that enable the contributor computers 127 to be used to make on-line contributions of ideas to the idea database 122 can be downloaded by the contributor computers 127 from the computer system 121. An on-line contribution is a contribution that is made over a communication network, such as the Internet.

The computer system 121 is programmed to enable receipt of contributions of ideas for prospective entry into the database 122, and to facilitate receipt of such contributions on-line from the contributor computers 127. In some preferred embodiments, the computer system 121 is programmed to record (a) the time of receipt of each idea contributed for entry into the idea database 122; (b) the time of publication in the idea database 122 of each accumulated idea; (c) the time of first viewing of each idea contributed to the idea database 122; and/or (d) the time of first public viewing from the idea database 122 of each accumulated idea, as indicated at 136 in FIG. 61.

In some preferred embodiments, the computer system 121 is programmed to systematically enter into the idea database 122 all the ideas contributed for entry into the database 122 without requiring any contributor of such ideas to have subject matter expertise as a prerequisite for entry of such contributions. In other preferred embodiments, the computer system 121 is programmed to require contributors of ideas to the database 122 to have subject matter expertise as a prerequisite for contributing ideas for prospective entry into the idea database 122, and facilitate entry of evidence of such expertise by on-line communications between the computer system 121 and the contributor computers 127. Such evidence can also be effected by other means, such as by mail. In still other preferred embodiments, the computer system 121 is programmed to selectively enter only some of the contributed ideas into the idea database 122. In some embodiments, selective entry is accomplished by systematic computer screening for relevant subject matter. In some embodiments, selective entry is accomplished by systematic computer screening for keywords and by a computer operator making a selective entry decision based upon the context in which the keywords are used.

In the preferred embodiments, the computer system 121 is programmed to require entities to enter into a membership as a prerequisite for viewing a portion of the idea database 122 containing at least some of the accumulated ideas, and to facilitate entry into such membership by on-line communications between the computer system 121 and the contributor computers 127. An entity may be a natural person; an organization, such as a corporation, company, partnership, association or the like; or a group of person(s) and/or organization(s) Entry into such a membership can also be effected by other means, such as by mail. Upon entering into a viewer membership, an entity agrees to give up some legal rights, such as by agreeing to nondisclosure agreements pertaining to given ideas accumulated in the idea database 122. In these preferred embodiments, the computer system 121 is programmed to enable 123 entities, whom have entered into a membership as a prerequisite for viewing the ideas accumulated in the idea database 122 to view 125, 126 accumulated ideas from the idea database 122, including ideas not respectively contributed by such entities.

In alternative embodiments, no such membership is required for on-line viewing of any portion of the idea database 122 by the general public.

The computer system 121 provides a search engine for keyword searching for selected ideas in the idea database 122. Once the selected idea has been found by such a search, the specific details of the selected idea can be accessed and viewed in computer generated display screens. These specific details include: (a) the type of idea submission: e.g., need, solution, or comment, (b) the title, (c) the author, (d) the idea certificate owner or the property rights owner if the property rights have been sold to a technology customer, (e) a textual description of the idea, (f) access links specifically directed to any attached supporting illustrations, (g) associated industry fields, (h) access links specifically directed to the parent node and the root need node if different from the parent node, (i) access links specifically directed to any children nodes, (j) the submittal date, (k) a rating of the idea, (1) access links specifically directed to prior art references and (m) access links specifically directed to associated idea submissions.

The computer system 121 facilitates the rating of the uniqueness, commercial usefulness, and appropriateness of idea submissions by members of the system by providing a rating screen display. The rating is limited to five levels, and is presented as questions as opposed to a numerical scale. The questions may appear as “Was this solution very unique?”, “Was this solution somewhat unique?”, “Was this solution very surprising?” and/or “Was this solution somewhat surprising?”. The computer system 121 enumerates the rating questions and provides an average rating based on a scale of one to five stars, with five stars being high.

In the preferred embodiments, the computer system 121 facilitates an auto-notification of ideas identified by member viewers. When members define a search criterion or create a favorite search criterion, they may also use that criterion for defining the basis of an auto-notification agent. The member specifies a periodic rate at which an automated search for a selected idea will be performed in the idea database 122. Any new results since the agent creation date or since the last time the search was performed, are forwarded to the member via Email without the member having to log into the computer system 121. Since it will be possible for a member to specify multiple auto-notification agents, the computer system 121 provides tools for managing a collection of auto-notification agents. This tool facilitates the creation, removal, activation, deactivation, and editing of auto-notification agents.

In the preferred embodiments, the computer system 121 is programmed to require contributors of ideas for prospective entry into the idea database 122 to enter into a membership as a prerequisite for contributing ideas for entry into the idea database 122, and to facilitate entry into such membership by on-line communications between the computer system 121 and the contributor computers 127. Entry into such a membership can also be effected by other means, such as by mail. In these preferred embodiments, the computer system 121 is programmed to enable 123 entities, whom have entered into a membership as a prerequisite for contributing ideas to the idea database 122, to view 125, 126 accumulated ideas from the idea database 122, including ideas not respectively contributed by such entities.

Upon entering into a contributor membership, an entity is required to agree to transfer property rights related to any inventions derived from any idea contributed by the entity, and in some embodiments may also be required to agree to give up some additional legal rights with respect to ideas contributed by the entity.

In the preferred embodiments, the computer system 121 is programmed to systematically facilitate establishment of contractual obligations 129 by contributors of the ideas to the idea database 122 by on-line communications between the computer system 121 and the contributor computers 127. With regard to some of the contractual obligations 129, in some embodiments the entities that are obligated generally are not employees of the proprietor 120 or employees of a party in concert with the proprietor 120. In the preferred embodiments, these systematically established contractual obligations 129 include at least: obligations by contributors of ideas to the idea database to transfer property rights related to inventions respectively derived at least in part from the contributed ideas to transferees determined by the proprietor of the database, whom in some embodiments are restricted to other than contributors of ideas of needs and/or requirements of the respectively derived inventions. Such obligations may include (b) obligations by contributors of ideas to the idea database 122 to transfer such property rights to the proprietor 120 of the idea database 122.

In some embodiments, these systematically established contractual obligations 129 by contributor entities of ideas to the idea database 122 also include: (a) nondisclosure agreements pertaining to given ideas accumulated in the database 122; (b) joint inventor agreements to file as a joint inventor any patent application for any invention derived from a combination of any ideas contributed to the idea database 122 by such entity and given accumulated ideas contributed to the idea database 122 by other entities; (c) patent application agreements including a covenant by the contributor not to file, without permission of the proprietor 120 of the idea database 122, a patent application for any invention related to a given idea accumulated in the idea database 122 until after an established period of time subsequent to accumulation of the given idea, and a covenant by the contributor that if he/she or any successor in title to such patent application and any patents issuing therefrom ever claims a priority date within said established period for the related invention, title to such patent application and any patents issuing therefrom shall be transferred to the proprietor 120 of the idea database 122 or the proprietor's nominee; (d) third party source identification agreements to disclose the identity of any third-party sources of ideas contributed by such entity that are related to given ideas accumulated in the idea database 122; and (e) inventor identification agreements to disclose the identity of each inventor of any invention derived from ideas contributed by such entity that are related to given ideas accumulated in the idea database 122.

The idea manager 120, systematically provides contingent contractual rights 140 to at least a portion of anticipated income derived from the property rights related to prospectively patentable inventions 124 respectively derived at least in part from ideas contributed to the computer database by the contributors whom receive such contingent contractual rights 140. The idea manager 120 systematically provides such contingent contractual rights 140 to the contributors of ideas to the idea database 122 as an incentive to contribute ideas to the idea database 122. These contingent contractual rights 140 are provided to contributors of the ideas in exchange for the contractual obligations 129 to transfer the property rights related to the inventions.

In some preferred embodiments the respective contractually obligated contributors generally are not employees of a proprietor of the idea database 122 or employees of a party in concert with the proprietor.

The idea manager 120 systematically facilitates transfer of the property rights 148 by the contributors of ideas to the idea database 122 to a transferee determined by the proprietor. In some of these embodiments, the transfers of property rights 148 are to transferees other than contributors of ideas from which the invention was at least in part derived. In some of the embodiments, the transfer of property rights 148 is to a proprietor of the idea database 122, such as the idea manager 120, or to a party in concert with such proprietor 120. In some of these embodiments, the transferees are not identified upon establishing such obligations; and in some of these embodiments, the transferees are identified upon establishing such obligations.

Management of the property rights and the contingent contractual rights are described in more detail in incorporated-by-reference International Patent Application Publication No. WO 02/17143 A1 and in a United States patent application entitled “Management Of Rights Related To Inventions Derived From Ideas Accumulated In A Computer Database” the disclosure of which is incorporated herein by reference thereto.

One exemplary embodiment of the organization of an integrated idea in a computer database is shown in FIG. 62, wherein bi-directional URL access links are provided between a problem idea (square) and one or more solution ideas (circle), and bi-directional URL access links are provided between a solution idea and one or more problem ideas, but generally not between a plurality of problem ideas or between a plurality of solution ideas. In this exemplary embodiment, three solution ideas 102, 103, 106 have been contributed in response to contribution of an initial problem idea 101; two problem ideas 104, 105 have been contributed in response to contribution of both of the solution ideas 102, 103, a solution idea 106 has been contributed in response to both of the problem ideas 101, 105; two problem ideas 107, 109 have been contributed in response to contribution of the solution idea 106; a solution idea 108 has been contributed in response to the problem idea 107; a problem idea 109 has been contributed in response to both of the solution ideas 106, 108; a solution idea 110 has been contributed in response to the problem idea 109; a problem idea 111 has been contributed in response to both of the solution ideas 108, 110; and a solution idea 112 has been contributed in response to the problem idea 111.

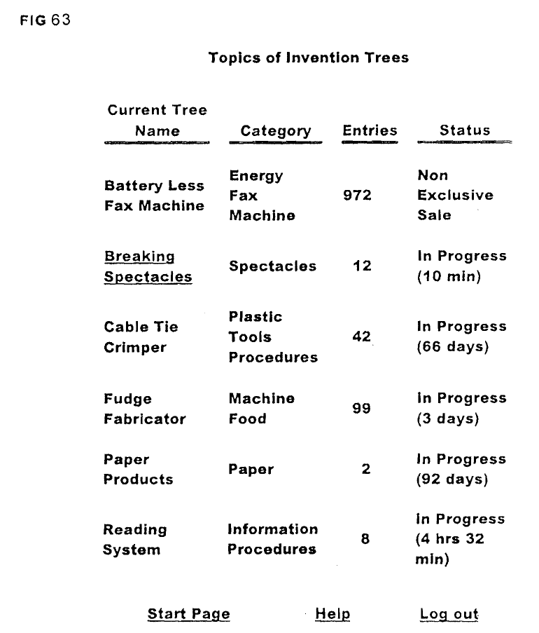

The idea contributions shown in FIG. 62 are described in detail in incorporated-by-reference International Patent Application Publication No. WO 02/17143 A1. Screen displays that are provided to a user of the idea database are shown in FIGS. 3 through 54 of WO 02/17143 A1. Some of such screen displays are reproduced herein as FIGS. 63-66, which FIG. numbers do not correspond to the FIG. numbers in WO 02/17143 A1.

The idea manager 120 provides a website from which the idea database 122 can be accessed for viewing and/or for entry of ideas therein. Access to the idea database 122 usually is over the Internet. A display of the web site provides a menu from which a user may select listings of (a) titles of the most recently contributed ideas; (b) titles of ideas that have received the most hits by users accessing the database; (c) integrated ideas combining the greatest number of prior ideas (such as the individual files respectively providing reference to the greatest number of files that are related either directly or indirectly to the identification code of another idea in the database); (d) the most recent integrated ideas (e) the identification codes, names or pseudonyms of the contributors whom have supplied the most ideas to the database; and (f) the identification codes, names or pseudonyms of the contributors whom have supplied the most ideas to the database for which rights have been provided/transferred. Such listings include links for accessing the ideas listed therein. Users can register for being notified by email of new entries of ideas having selected key words in the idea title and/or text; and such users are then so notified. The email notification includes a link to the new entry in the database.

A contributor enters an idea by text and/or attachment entry and/or by using software downloaded from the idea manager's website, or otherwise provided by the idea manager (such as in a compact disc), to enter drawings.

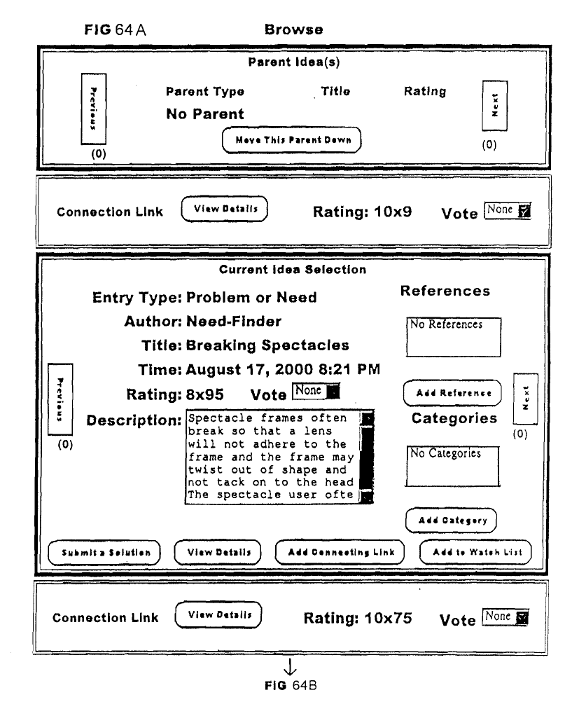

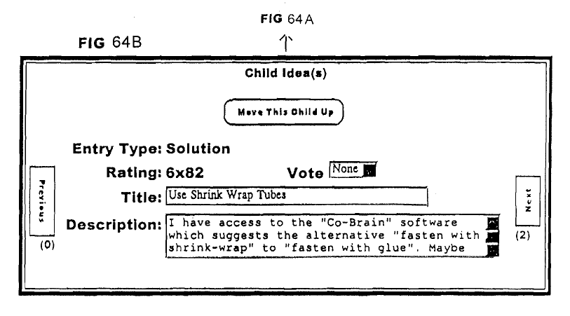

Upon displaying the “Topics of Invention Trees” screen display of FIG. 63, a contributor can select and browse prior contributions that have been published in the database. The “Breaking Spectacles” link provides access to the exemplary integrated idea described above with reference to FIG. 62, beginning with the screen display of FIG. 64. The format of the screen display for a selected idea (as shown in FIGS. 19-42 of WO 02/17143 A1) includes a “Current Idea Selection” section, a Parent section, a “Child Idea(s)” section, a first “Connection Link” section between the Parent section and the Current Idea Selection section, and a second “Connection Link” section between the Child Idea(s) section and the Current Selection section.

The Current Idea Selection section contains a Description of the selected idea and a Vote window and lists the Entry Type of the selected idea, such as “Problem or Need” or “Solution”; the Author (contributor) of the selected idea, the Title of the selected idea, the Time of Publication of the selected idea, a Rating of the appropriateness of the selected idea, any References related to the selected idea, and any Categories related to the selected idea. The Current Idea Selection section also includes Previous and Next buttons for accessing other contributed ideas that are linked to the same parent idea as the selected idea. The quantity of any such other linked contributed ideas are indicated beneath the Previous and Next buttons.

The Parent section contains a Vote window and lists the Type of the linked parent idea, such as “Problem or Need” or “Solution”; the Title of the linked parent idea, and, a Rating of the appropriateness of the linked parent idea. The Parent section also includes Previous and Next buttons for accessing other contributed parent ideas that are linked to the selected idea, and indicates the quantity of any such other linked contributed parent ideas.

The Child Idea(s) section contains a Description of the linked child idea and a Vote window and lists the Entry Type of the linked child idea, such as “Problem or Need” or “Solution”; the Title of the selected idea, and a Rating of the appropriateness of the linked child idea. The Child Idea(s) section also includes Previous and Next buttons for accessing other contributed child ideas that are linked to the selected idea, and indicates the quantity of any such other linked contributed child ideas.

The ratings are provided in response to averaging (or processing by some other formula) the votes by users of the database. Voting is accomplished by selecting a number within a range of 0 to 10 from a drop-down menu displayed by clicking the down-arrow in the Vote window. The listed rating shows the average (or other) rating and the number of voters. Ratings are also listed in the two “Connection Link” sections for the appropriateness of the respective links between the selected idea and either the idea in the Parent section or the idea in the Child Idea(s) section. The ratings provide a user of the database with an immediate indication of the appropriateness of the rated idea or connection link, as voted by other users.

In the screen display of FIG. 64, the selected idea described in the Current Idea Selection section is Problem Idea 101, and the child idea described in the Child Idea(s) section is Solution Idea 106, shown in FIG. 62.

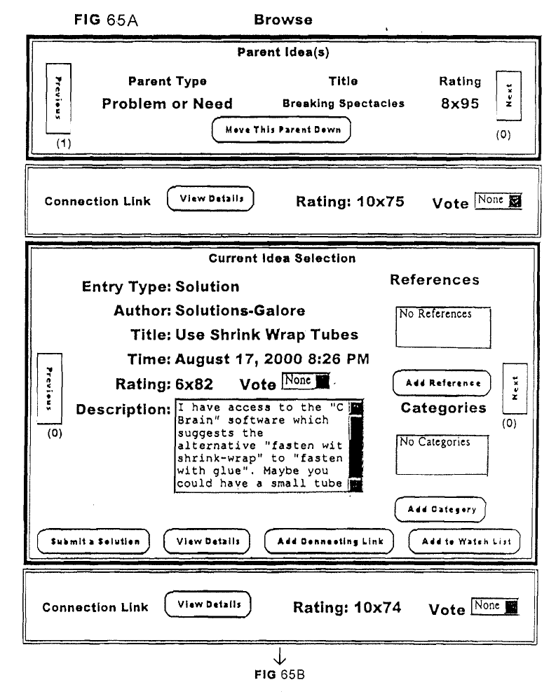

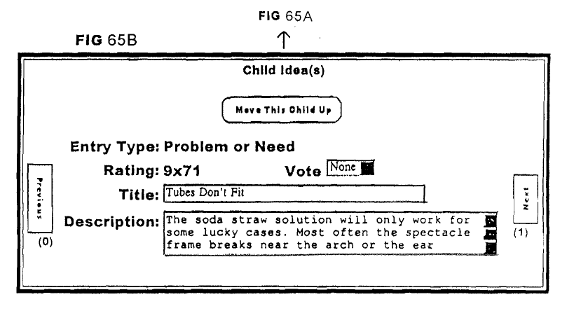

A screen display, as shown in FIG. 65, in which the child idea in the Child Idea(s) section of the screen display of FIG. 64 is displayed as the selected idea in the Current Idea Selection section, is accessed by clicking the “Move This Child Up” button in the Child Idea(s) section, in the screen display of FIG. 64. In the screen display of FIG. 65, the selected idea described in the Current Idea Selection section is Solution Idea 106, the parent idea listed in the Parent section is Problem Idea 101, and the child idea described in the Child Idea(s) section is Problem Idea 107, shown in FIG. 62.

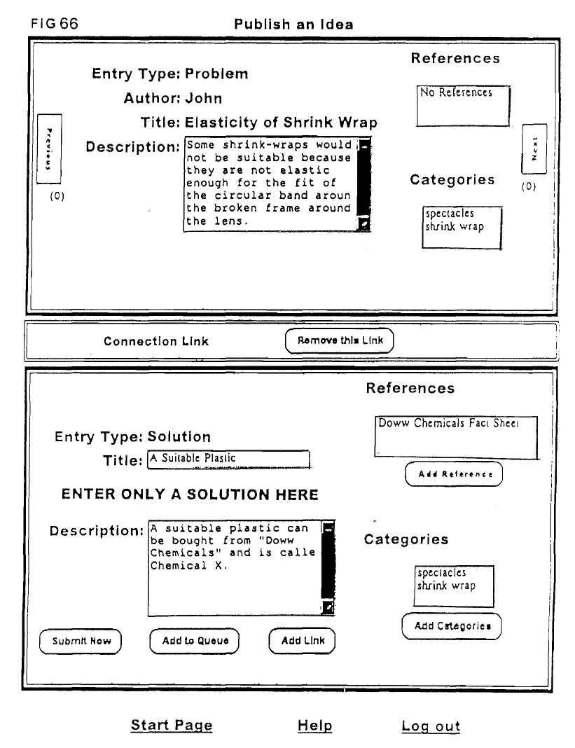

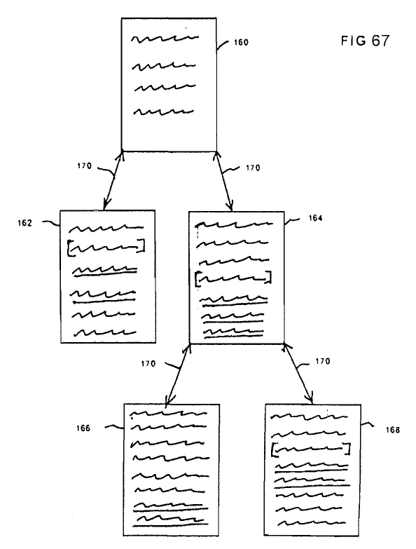

When a contributor desires to contribute a comment in response to a comment displayed in the Description form element of the Current Idea Selection section of a display screen, such as shown in FIG. 64, the contributor clicks the “Submit a Solution” button, which provides access to the “Publish an Idea” display screen of FIG. 66.

The Publish an Idea screen display of FIG. 66 includes an upper section for describing a first idea, a lower section for describing a second idea and a “Connection Link” section. The first idea is linked bi-directionally to the second idea unless the link is removed by clicking the “Remove This Link” button in the Connection Link section. The display in the upper section corresponds to the Current Idea Selection section of a browse-mode display screen, such as shown in FIG. 64. The display in the lower section systematically directs the contributor to contribute the responsive comment for entry into the database by using a computer-displayed Description form element portion of the screen display, which is adapted for receiving such contribution. Such direction includes systematically directing the contributor to contribute a solution comment in the lower section in response to the display of a problem comment in the upper section, such as shown in FIG. 66, and to contribute a problem comment in the lower section in response to the display of a solution comment in the upper section (not shown). Accordingly, the lower section of the display screen of FIG. 66 indicates “Entry Type Solution” and an also displays an instruction reading: ENTER ONLY A SOLUTION HERE. When a solution comment is displayed in the upper section of the Publish an Idea screen display, the display screen of FIG. 66

indicates Entry Type: Problem or Need and an also displays an instruction reading: ENTER ONLY A PROBLEM OR NEED HERE (not shown).

Text is manually entered into the “Title and Description” form element portions of the lower section. The entered text may be added to a queue for submission with other entries by clicking the “Add to Queue” button in the lower section.

The queue is a storage area or scratch book for contributor members to store and organize sets of contributed ideas and sets of connection links before they are submitted to the idea database 122. Contributed ideas and connecting links may then be submitted as a unit in a member-organized configuration. Connection links within the queue may connect two contributed ideas within the queue, two currently published contributed ideas within the database, or a contributed idea within the queue and a currently published contributed idea within the database. Until submitted to the idea database 122 individually or as a part of a unit in a member-organized configuration, the idea files in the queue and/or their organization within one or more units, as defined by their connection links, may be modified, deleted, moved, or recombined by the contributor member. New contributed ideas and connection links may be added to the queue. Means are provided for selecting contributed ideas and connection links for submission to the idea database 122 as an organized unit or individually. Submission to the idea database 122 is not limited by the order in which the contributed ideas and the connection links are created. Contributed ideas and connection links in the queue that are not submitted when other contributed ideas and connection links in the queue are submitted are saved for later manipulation and/or submission to the idea database. The computer system 121 managing the idea database 122 does not process or publish contributed ideas or related connection links until the entire unit containing the contributed ideas and the related connection links is submitted. Partially received units are treated in the same manner as a partially received contributed idea or a partially received connection link; and the same time of receipt is recorded for all of the contributed ideas and connection links that are submitted as part of a unit. Upon publication in the idea database 122, the same time of publication is listed for all of the contributed ideas and connection links that are submitted as part of a unit.

In the various embodiments of this invention the step of facilitating contribution of ideas to the idea database 122 preferably is carried out automatically by the computer system 121. One example of such step being carried out automatically by the computer system would be as follows: In the exemplary embodiment described with reference to FIG. 62, where Idea 104 is contributed as a child of Idea 102 this step is accomplished by a human contributor; and where Idea 104 is contributed as a child of Idea 103, this latter contribution is accomplished automatically by a computer that is used to manage and provide the idea database in response to the computer recognizing the similarity of the words of Idea 102 and Idea 103. Such technology is known, and for example, is provided at http://www.cobrain.com. If an idea automatically contributed by a computer is inappropriate the idea will get a very low rating by the database users.

In accordance with the embodiment described with reference to FIGS. 62-66, invention-idea products, are produced by a method including the steps of: (a) accumulating contributions of ideas pertaining to prospectively patentable inventions in a computer database; (b) integrating related idea contributions by bi-directional URL access links to produce invention-idea products that facilitate derivation of inventions from said integrated ideas; and (c) providing a plurality of screen displays respectively containing said plurality of idea contributions and said access links. In a preferred embodiment, as described with reference to FIG. 66, the method further includes the steps of: (d) systematically directing a contributor of an idea, which is related to an idea contained in a given said screen display, to contribute said related idea by using a form element, contained in said given screen display of the parent contribution, and adapted for receiving said related idea contribution; and (f) providing a bi-directional URL access link between a screen display containing the related idea contribution and the given screen display.

The embodiment of FIGS. 62-66 provides an invention-idea product embodied in computer-readable signals embodied in carrier waves or in computer-readable information storage medium(media), comprising: a plurality of contributions of related ideas for prospectively patentable inventions; wherein the contributions of related ideas are integrated by bi-directional URL access links; and a plurality of screen displays respectively containing the plurality of idea contributions and the access links. In a preferred embodiment of this product, the screen displays respectively contain: a given form element for receiving an idea contribution related to the idea contribution contained in a said screen display; and a direction to use the given form element to contribute the related idea.

In an alternative preferred embodiment, the idea contributions are integrated as shown in FIG. 67 to provide an invention-idea product embodied in computer-readable signals embodied in carrier waves or in computer-readable information storage medium(media). The illustrated embodiment of the invention-idea product includes a plurality of contributions 160, 162, 164, 166, 168 of related ideas for prospectively patentable inventions. The related idea contributions 160, 162, 164, 166, 168 are integrated by URL access links 170. Each of the idea contributions is contained in a screen display, such as shown in FIGS. 64 and 65. The access links 170 between a derived idea contribution and its respective parent idea contribution are also contained in the screen displays.

The idea contributions, such as idea contributions 162, 164, that are derived from a parent idea contribution, such as idea contribution 160, are derived by editing the parent idea contribution 160. The idea contributions 166, 168 are derived from idea contribution 164.

The screen display provides a direction to contribute a related idea by copying and editing the idea contribution contained in the screen display. The screen display also includes a button, that is clicked to cause the computer system 121 to enable the idea contribution contained in the screen display to be copied and displayed for editing to thereby contribute said related idea. The computer system 121 provides a word processing routine that is used to edit the copy of the parent idea contribution.

The derived idea contributions 162, 164 and 166, 168 respectively include indicia of the differences between the derived idea contribution 162, 164 and 166, 168 and their respective parent idea contribution 160 and 164. In the embodiment shown in FIG. 67, the indicia are indicated by brackets about deleted text and underlining of added text. Other indicia, such as highlighting and lining-out, as provided in some word processing routines, are used in an alternative embodiment.

The text of the copied idea contribution, which is provided for editing by the computer system 121 in response to clicking the button on the screen display, does not include the indicia of the differences between the copied idea contribution and any parent idea contribution to the copied idea contribution.

The present invention also provides methods of producing an invention, wherein the invention is derived from an invention-idea product produced by one of the methods described herein.

Another embodiment of a method of producing inventions includes the steps of: (a) facilitating accumulation in a computer database of contributions of ideas for prospectively patentable inventions; (b) facilitating access of said accumulated idea contributions from said computer database; (c) directing idea contributors to contribute to said computer database an idea related to a said accessed idea contribution that is an improvement of said accessed idea contribution, and facilitating said contribution to thereby facilitate derivation of a prospectively patentable invention from said accessed idea contribution.

Still another embodiment of a method of producing inventions includes the steps of: (a) maintaining a computer database for accumulating idea contributions, at least some of which individually do not disclose inventions for which a patent application has been filed, the written disclosure of which is embodied in a computer-readable information storage medium/media of the database; (b) accumulating the idea contributions in the database by providing means for repetitiously receiving idea contributions from more than one contributor in accordance with the steps of: (c) providing means for and directing contributors of idea contributions to access one or more accumulated idea contributions; (d) providing means for and directing contributors of idea contributions to contribute an additional idea contribution that is at least partially derived from, and a prospective improvement to said accessed idea contributions; and (e) accumulating the additional idea contribution in the database. The method may further include the step of: (f) providing means for contributors of idea contributions to search for an accumulated idea contribution directed to subject matter selected by the contributors.

In some preferred embodiments, the idea manager 120 also systematically facilitates preparation and/or filing of patent applications, as indicated at 150, for at least some of the unpatented inventions respectively derived at least in part from at least one of the ideas accumulated in the idea database 122. Preferably, for some inventions, the step 148 of facilitating transfer of at least some right under the patent rights is carried out systematically before the step 150 of facilitating preparation and/or filing of a patent application. The computer system 121 is used to derive the patent applications from ideas accumulated in the idea database 122. Computer software for deriving patent applications from a database including an idea of an invention includes “Patent Pro” brand software available from Kernel Creations, Ltd. and “Patent Wizard” brand software available from Patent Wizard, LLC of Fargo, N. Dak. Computer software for filing patent applications in various national patent offices has been provided by the various national patent offices.

Preferably all of the various functions described herein are performed systematically. In alternative embodiments some of the various functions described herein are not performed systematically.

The present invention further provides computer readable storage media for use with computer systems, wherein the computer readable storage media include computer executable instructions for causing computer systems to perform and/or enable performance of the various functions described herein.

In still other embodiments the various embodiments described herein are combined with one another to the extent that they are not incompatible with each other.

The benefits specifically stated herein do not necessarily apply to every conceivable embodiment of the present invention. Further, such stated benefits of the present invention are only examples and should not be construed as the only benefits of the present invention.

While the above description contains many specificities, these specificities are not to be construed as limitations on the scope of the present invention, but rather as examples of the preferred embodiments described herein. Other variations are possible and the scope of the present invention are to be determined not by the embodiments described herein but rather by the claims and their legal equivalents. The claims require no implicit limitations. Each claim is to be construed explicitly as stated, or by its legal equivalent.

What is claimed is:

1. A computer-implemented method for deriving prospectively patentable inventions with a database, the method comprising:
(a) maintaining a computer database for accumulating idea contributions for prospectively patentable inventions;
(b) establishing nondisclosure agreements by at least some prospective contributors of idea contributions for the database;
(c) establishing contractual obligations by prospective contributors of idea contributions to the database to transfer property rights of the contributors to prospectively patentable inventions, derived at least in part from the contributed idea contributions;
(d) editing the idea contributions in the database;
(e) accumulating a plurality of the idea contributions in the database, wherein at least one of the idea contributions comprise at least one parent idea contribution, at least one idea contribution from which the parent idea contribution was previously derived, and at least one child idea contribution and wherein the child idea contribution was derived from the parent idea contribution by the editing of the parent idea contribution, and wherein the child idea is a prospective improvement of the parent idea; and
(f) displaying the child idea contribution so as to include indicia of differences between the child idea contribution and the parent idea contribution and so as to not include indicia of differences between the parent idea contribution and the idea contribution from which the parent idea contribution was previously derived.
